(19) United States
(12) Patent Application Publication
(10) Pub. No.: US 2026/0070068 A1
(43) Pub. Date: Mar. 12, 2026

(54) AMMONIATED POLYCARBAMIDE SEPARATION AIDS FOR MINERAL FLOTATION

(71) Applicant: Hexion Inc., Columbus, OH (US)

(72) Inventors: Byung Young No, Eugene, OR (US); John W. Green, Cypress, TX (US); Cedar C. Lechner-Riehle, Cottage Grove, OR (US); Robbie B. Currie, Melbourne (AU); Matthew Ting, Brimbank (AU)

(73) Assignee: Hexion Inc., Columbus, OH (US)

(21) Appl. No.: 19/313,394

(22) Filed: Aug. 28, 2025

Related U.S. Application Data
(60) Provisional application No. 63/691,396, filed on Sep. 6, 2024.
(60) Provisional application No. 63/691,417, filed on Sep. 6, 2024.
(60) Provisional application No. 63/691,430, filed on Sep. 6, 2024.
(60) Provisional application No. 63/712,104, filed on Oct. 25, 2024.
(60) Provisional application No. 63/712,125, filed on Oct. 25, 2024.
(60) Provisional application No. 63/712,139, filed on Oct. 25, 2024.
(60) Provisional application No. 63/744,033, filed on Jan. 10, 2025.
(60) Provisional application No. 63/744,057, filed on Jan. 10, 2025.
(60) Provisional application No. 63/744,071, filed on Jan. 10, 2025.
(60) Provisional application No. 63/744,099, filed on Jan. 10, 2025.
(60) Provisional application No. 63/744,119, filed on Jan. 10, 2025.
(60) Provisional application No. 63/744,131, filed on Jan. 10, 2025.
(60) Provisional application No. 63/760,860, filed on Feb. 20, 2025.

(51) Int. Cl. B03D 1/016; B03D 1/002; B03D 1/006; B03D 1/012; B03D 1/02

(52) U.S. Cl. CPC B03D 1/016; B03D 1/002; B03D 1/006; B03D 1/012; B03D 1/02; B03D 2201/007; B03D 2201/02; B03D 2201/06; B03D 2203/02

(57) ABSTRACT

Compositions and methods for the separation and recovery of one or more minerals from a mineral ore bulk material are provided. The compositions and methods include selectively depressing minerals utilizing an ammoniated polycarbamide as a separation aid. The ammoniated polycarbamide reduces, or eliminates, the conventional use of depressants such as sodium hydrosulfide (NaSH) in mining flotation processes, including copper-molybdenum (Cu—Mo) separations.

### RELATED APPLICATIONS

This application claims priority to and any benefit of U.S. Provisional Application No. 63/691,396, filed on Sep. 6, 2024, U.S. Provisional Application No. 63/691,417, filed on Sep. 6, 2024, U.S. Provisional Application No. 63/691,430, filed on Sep. 6, 2024, U.S. Provisional Application No. 63/712,104, filed on Oct. 25, 2024, U.S. Provisional Application No. 63/712,125, filed on Oct. 25, 2024, U.S. Provisional Application No. 63/712,139, filed on Oct. 25, 2024, U.S. Provisional Application No. 63/744,033, filed on Jan. 10, 2025, U.S. Provisional Application No. 63/744,057, filed on Jan. 10, 2025, U.S. Provisional Application No. 63/744,071, filed on Jan. 10, 2025, U.S. Provisional Application No. 63/744,099, filed on Jan. 10, 2025, U.S. Provisional Application No. 63/744,119, filed on Jan. 10, 2025, U.S. Provisional Application No. 63/744,131, filed on Jan. 10, 2025, and U.S. Provisional Application No. 63/760,860, filed on Feb. 20, 2025, the contents of which are incorporated herein by reference in their entireties.

### FIELD

The invention relates to methods and compositions and for the separation and recovery of one or more minerals from a mineral ore bulk material. More particularly, the invention relates to methods of selectively depressing minerals utilizing a separation aid containing an ammoniated polycarbamide. An ammoniated polycarbamide reduces, or eliminates, the conventional use of inorganic depressants such as sodium hydrosulfide (NaSH) in mining flotation processes, including copper-molybdenum (Cu—Mo) separations.

### BACKGROUND

Flotation methods, such as froth flotation, are utilized in the mining industry to selectively extract a desired mineral from a mineral ore bulk material. Industrial mining flotation processes generally include the separation of a bulk material into a floated concentrate and flotation tailings. For example, copper-molybdenum (Cu—Mo) operations seek to selectively separate and recover the small amount of high-value molybdenum (Mo) minerals from a mineral ore bulk material primarily comprised of copper sulfide minerals, pyrite, and non-sulfide gangue. The minerals are referred to by the valuable metal in the mineral itself.

Conventionally, Cu—Mo mining flotation mills have utilized inorganic depressants such as sodium hydrosulfide (NaSH) to selectively depress the copper minerals (Cu) from the mineral ore bulk material. Molybdenum minerals (Mo) and copper minerals (Cu) are inherently hydrophobic, and float in a flotation system. Thus, to separate out the Mo from the Cu in froth flotation, the Cu minerals first must be depressed. In conventional processes, NaSH forms hydrogen sulfide ions and desorbs collectors from Cu minerals, resulting in the depression of Cu. In addition to NaSH, other inorganic reagents are also conventionally used as separation aids to separate Cu from Mo in Cu—Mo mining processes, including sodium sulfide (Na₂S), Nokes reagent (P₂S₅/NaOH), and sodium cyanide (NaCN).

That said, these conventional depressant chemicals, including NaSH, exhibit hazards such as strong odor, flammability, and the potential generation of toxic hydrogen sulfide (H₂S) gas and/or toxic hydrogen cyanide gas. Additionally, these conventional depressant chemicals create manufacturing and logistical challenges. The requisite dosage of NaSH to depress Cu effectively is significant, thus requiring a high consumption of NaSH in industrial facilities, and resulting in substantial cost related to the transportation, handling, and storage of large quantities of hazardous chemicals.

As such, a need exists for methods of selectively depressing minerals in mining flotation processes with a separation aid that reduces, or eliminates, the use of conventional hazardous inorganic reagents such as NaSH, while still maintaining the requisite functionality of a depressant in mining technologies, particularly Cu—Mo mining technologies. The replacement of conventional depressants such as NaSH would provide substantial economic, environmental, health, and safety benefits to the mining industry, including the Cu—Mo mining industry.

### SUMMARY

This invention relates to methods and compositions for the separation and recovery of one or more minerals from a mineral ore bulk material. The methods include selectively depressing minerals utilizing a separation aid containing an ammoniated polycarbamide, which reduces, or eliminates, the conventional use of separation aids such as sodium hydrosulfide (NaSH) in mining flotation processes, including copper-molybdenum (Cu—Mo) separations.

The method for the separation and recovery of one or more minerals from a mineral ore bulk material includes the steps of: forming an aqueous pulp comprising water, a mineral ore bulk material, and a separation aid; agitating and floating the aqueous pulp to form a floated mineral concentrate and flotation tailings; and separately recovering the floated mineral concentrate and flotation tailings. The aqueous pulp may be formed by adding the mineral ore bulk material to the water to form a slurry; mixing the slurry; and adding the separation aid to the slurry while mixing to form the aqueous pulp. The step of agitating and floating the aqueous pulp comprises introducing air at a suitable flow rate to the aqueous pulp thereby floating the floated mineral concentrate.

In certain aspects, the floated mineral concentrate comprises molybdenum and the flotation tailings comprise copper, iron (Fe), or combinations thereof.

A separation aid of the invention may further include an ammoniated polycarbamide, 0.01 wt. % to 10 wt. % of a biopolymer; and 0.2 to 15 wt. % of a supplemental depressant. The ammoniated polycarbamide is a reaction product of formaldehyde, urea, and ammonia wherein a mole ratio of formaldehyde to a combination of urea and ammonia is from 1 to 4. The separation aid may optionally include a sulfur compound, a hydrophilic polymer, a supplemental depressant, or mixtures thereof.

A separation aid of the invention may further include an ammoniated polycarbamide, 0.1 wt. % to 20 wt. % of a hydrophilic polymer; and 0.2 to 15 wt. % of a supplemental depressant. The ammoniated polycarbamide is a reaction product of formaldehyde, urea, and ammonia wherein a mole ratio of formaldehyde to a combination of urea and ammonia is from 1 to 4. The separation aid may optionally include a sulfur compound, a biopolymer, a supplemental depressant, or mixtures thereof.

If present, the biopolymer may comprise one or more of a lignin-based polymer, a polysaccharide, a starch, a hydrocolloid, flour, a soy protein, or combinations thereof. The lignin-based polymer may comprise a lignosulfonate, such as sodium lignosulfonate, calcium lignosulfonate, ammonium lignosulfonate, magnesium lignosulfonate, or mixtures thereof. Exemplary hydrocolloids include anionic hydrocolloids, nonionic hydrocolloids, or combinations thereof. Exemplary starches include natural starch, modified starch, or combinations thereof. The separation aid may optionally include a sulfur compound, a hydrophilic polymer, a supplemental depressant, or mixtures thereof.

If present, the hydrophilic polymer may be an acrylamide polymer, such as, for example, N-methylolacrylamide polymer, polyacrylamide, sodium polyacrylate, potassium polyacrylate, poly(N,N-dimethylacrylamide), sodium polymethacrylate, or combinations thereof. If present, the hydrophilic polymer may be included in the separation aid in an amount from 0.1 wt. % to 20 wt. %.

The supplemental depressant and polycarbamide may be pre-mixed prior to the addition of the separation aid to the aqueous pulp, or the components may be added separately. Exemplary supplemental depressants thioglycolic acid (TGA) include salts, ethylenediaminetetraacetic acid (EDTA) salts, mercaptosuccinic acid (MSA) salts, thioglycerin (TG) salts, or combinations thereof. Exemplary thioglycolic acid (TGA) salts include those selected from the group consisting of sodium thioglycolate (S-TGA), calcium thioglycolate (C-TGA), diethylenetriamine thioglycolate (D-TGA), ammonium thioglycolate (A-TGA), or combinations thereof. Exemplary mercaptosuccinic acid salts include disodium mercaptosuccinate (S-MSA), sodium thioglycerolate (S-TG), or combinations thereof. Exemplary EDTA salts include disodium EDTA (S-EDTA), sodium calcium edetate, and tetrasodium EDTA, or combinations thereof.

In some aspects, the supplemental depressant may further include one or more of sodium hydrosulfide (NaSH), sodium sulfide (Na₂S), Nokes reagent, sodium cyanide (NaCN), or combinations thereof, although in certain instances, the separation aid may be free, or substantially free of sodium hydrosulfide (NaSH).

A separation aid of the invention may further include a sulfur compound as a performance enhancing supplement. The sulfur compound may include an ionizable thiol group. The sulfur compound may comprise a sulfite, a sulfate, a thiol-functional compound, a sulfide, a sulfamate, a sulfinic acid, or combinations thereof. In some aspects, the supplementary sulfur compound comprises a sulfide, a disulfide, a sulfinic ester, a thiocyanate, a thiocarboxylic acid, a thioester, a sulfinic acid, a dithiocarboxylic acid, a dithiocarboxylic acid ester, a sulfamate, a sulfamide, salts of any of the above, or combinations thereof.

Aspects of the invention are further directed to the use of an ammoniated polycarbamide as a separation aid in a mineral ore separation process.

### BRIEF DESCRIPTION OF THE DRAWINGS

The general inventive concepts will be described in greater detail with reference to the drawings in which:

FIGS. 1 and 2 graphically illustrate the results of lab-scale flotation cell tests of Example 4.

FIGS. 3 and 4 graphically illustrate the results of lab-scale flotation cell tests of Example 6.

### DETAILED DESCRIPTION

The invention relates to methods for the separation and recovery of one or more minerals from a mineral ore bulk material, including methods of selectively depressing minerals utilizing a separation aid containing an ammoniated polycarbamide, optionally modified with a biopolymer and/or a hydrophilic polymer. A “separation aid” is a compound or composition that facilitates the separation of minerals in a flotation mining process. The term “separation aid” may thus be understood to encompass mining reagents, depression agents, collection agents, and compositions containing them as well as any commonly used term to indicate such an agent for use in froth flotation processes. While describing certain aspects of the mining flotation methods and compositions in detail, the description is to be considered exemplary and is not intended to be limited to the invention.

Methods for Separation and Recovery of Minerals from Mineral Ore

The invention provides a method for the separation and recovery of one or more minerals from a mineral ore bulk material. The method includes the steps of: 1) forming an aqueous pulp comprising water, a mineral ore bulk material, a separation aid comprising an ammoniated polycarbamide, and optionally one or more mineral collectors; 2) agitating and floating the aqueous pulp to form a floated mineral concentrate and flotation tailings; and 3) separately recovering the floated mineral concentrate and flotation tailings. As will be described in more detail below, the ammoniated polycarbamide separation aid may be modified with a biopolymer, a hydrophilic polymer, or each of a biopolymer and a hydrophilic polymer.

As a first step, a method of the invention forms an aqueous pulp containing water, a mineral ore bulk material, a separation aid, and optionally one or more mineral collectors. The separation aid contains or itself is an ammoniated polycarbamide. The aqueous pulp may be formed by methods known in the art, for example, by adding the mineral ore bulk material to water to form a slurry, mixing the slurry, and adding the separation aid and optional mineral collector to the slurry while mixing to form the aqueous pulp. Prior to forming an aqueous pulp, the mineral ore bulk material may be subjected to a comminution process to produce smaller or finer mineral ore particles. The comminution process is not particularly limited, and may include any known methods of particle size reduction such as crushing, grinding, etc.

In general, the methods of the invention may be used with any mineral ore bulk material suitable for separation in flotation mining processes. The mineral ore bulk material may contain, inter alia, minerals including copper (Cu) and molybdenum (Mo) requiring separation. The mineral ore bulk material may also be a copper-molybdenum (Cu—Mo) concentrate.

After forming the aqueous pulp, the method includes the step of agitating and floating the aqueous pulp to form a floated mineral concentrate and flotation tailings. Agitating the aqueous pulp, alone or enhanced with the introduction of air, can result in “froth” of air bubbles with minerals and optionally mineral collectors attached to the air bubbles. This froth forms all or part of the floated mineral concentrate. The optional mineral collectors may be included in the aqueous pulp to increase the hydrophobicity of the minerals to be floated, such as molybdenum (also referred to as a Mo collector). The mineral collectors may include, for example, liquid hydrocarbons, hydroxyamide, pine oil, kerosine, diesel, and the like.

The step of agitating and floating the aqueous pulp may comprise introducing a gas, such as air or nitrogen, into the aqueous pulp at a suitable flow rate to generate bubbles and agitating the aqueous pulp thereby causing a froth to form and floating a mineral concentrate. Conversely, the flotation tailings, which remain in the slurry, make up the residual of the mineral ore bulk material depressed using the separation aid and are not collected in the floated mineral concentrate.

Following the formation of the floated mineral concentrate and the flotation tailings, the method comprises separately recovering the floated mineral concentrate from the aqueous pulp. The particular equipment and procedure for recovering floated mineral concentrate is well known to those of skill in the art. For instance, the floated mineral concentrate may be periodically collected as froth that has accumulated on the surface of the aqueous pulp undergoing agitation. A suitable procedure for recovering the floated mineral concentrate is described in U.S. Pat. No. 10,654,048.

The type of recovered floated mineral concentrate is not limited and will depend on the mineral ore bulk material undergoing separation by a mining flotation process. Accordingly, the recovered floated mineral concentrate may be any mineral suitable for separation in flotation mining processes. In one aspect, the floated mineral concentrate contains molybdenum (Mo). Similarly, the type of recovered flotation tailing is not limited, and will depend on the mineral ore undergoing separation by a mining flotation process. The recovered flotation tailing may then be any mineral suitable for separation in flotation mining processes. For example, the flotation tailing may contain copper (Cu) and/or iron (Fe) minerals.

### Ammoniated Polycarbamides

A separation aid of the invention contains, or is itself, an ammoniated polycarbamide and functions to selectively depress one or more minerals in a flotation mining process. An ammoniated polycarbamide is generally more hydrophilic relative to the mineral it is being used to depress. When the ammoniated polycarbamide interacts with the mineral, it alters the relative wettability of the surface of the mineral making it more hydrophilic. This, in turn, acts to depress certain minerals during a flotation process.

The ammoniated polycarbamide may be prepared using a one-, two-, three- or more stage polymer synthesis process. The polymer synthesis stages may be completed in various sequences or synthesis routes. For instance, in a first exemplary synthesis route, a first stage may include the preparation of an ammoniated polycarbamide, and a second stage includes the addition of a sulfur compound as a performance enhancing supplement.

In a second exemplary synthesis route, a first stage includes the formation of an ammoniated polycarbamide, and a second stage modifies the ammoniated polycarbamide with a biopolymer. Optionally, additional stage(s) include the addition of sulfur compounds, as performance enhancing supplements, hydrophilic polymers, and/or supplemental depressants.

In a third exemplary synthesis route, a first stage includes the formation of an ammoniated polycarbamide and the modification of the ammoniated polycarbamide with a hydrophilic polymer, thereby forming a hydrophilic polymer-modified ammoniated polycarbamide. Optionally, additional stage(s) include the addition of sulfur compounds, as performance enhancing supplements, biopolymers, and/or supplemental depressants.

For clarity purposes, the process will be described herein as a series of stages and steps, but it should be appreciated that the various steps and stages of the synthesis process may not necessarily occur stepwise, but rather in some instances may occur simultaneously or in situ.

### Preparation of an Ammoniated Polycarbamide

The methods of forming the ammoniated polycarbamide are not limited and may include any known polymer syntheses. An ammoniated polycarbamide may be formed via a two-step process, including: a first step of combining formaldehyde, urea, and ammonia; and a second step of controlling the degree of polymerization of the ammoniated polycarbamide.

Ammonia improves the storage stability of the polycarbamide as well as its hydrophilic characteristics, which allow for depression of minerals such as copper and iron. Unless specified otherwise, the term “ammonia” may include aqua ammonia, ammonia solution, ammonium hydroxide, ammonia water, ammoniacal liquor, ammonia liquor, aqueous ammonia, and other ammonia-based precursors that may be utilized in the synthesis of the subject ammoniated polycarbamides.

In an exemplary method, the first step of forming the ammoniated polycarbamide includes charging formaldehyde into a reactor and adjusting the pH of the formaldehyde solution to a neutral or alkaline pH. The formaldehyde may be paraformaldehyde (i.e., 100% formaldehyde), or aqueous formaldehyde having a concentration up to 60% formaldehyde, including, for example, formaldehyde concentrations of 20%-58%, 25%-55%, and 30%-53%. Aqueous formaldehyde having an amount of formaldehyde greater than 20% is preferred. When paraformaldehyde is used, an amount of water may also be charged to the reactor to form an aqueous formaldehyde solution. The pH of the formaldehyde solution is adjusted to a neutral or alkaline pH, for example, a pH of 7 to 9, such as, for example, a pH of 7.2 to 8.4, or about 7.4 to 8.2, or about 7.5. Any pH adjuster known in the art may be used. Exemplary pH adjusters include, but are not limited to, triethanolamine (TEA), sodium hydroxide (NaOH), sulfuric acid, formic acid, and the like.

A first urea charge (U₁) is added to the formaldehyde solution. The first urea charge (U₁) may constitute the total urea (U) of the ammoniated polycarbamide. In other aspects, the total urea (U) may include multiple urea charges at different steps in the synthesis process. Ammonia is added to the combination of formaldehyde and urea, and the system is held to allow it to react and form an ammoniated polycarbamide. The reaction is heated (via exotherm and an additional heat source) and held at an elevated temperature; for example, at a temperature from 90° C. to 110° C., from 90° C. to 107° C., from 95° C. to 105° C., or from 99° C. to 102° C. The reaction is held for a time sufficient to form various (hydroxymethyl) urea intermediates. For example, the reaction may be held for a period of 30 to 60 minutes, 30 to 45 minutes, or 40 to 50 minutes.

The second step of forming an ammoniated polycarbamide controls the degree of polymerization via targeted adjustments to the system. The synthesis of an ammoniated polycarbamide may take place under acidic conditions, including at a pH of less than 7, such as a pH of 3 to 6, a pH of 3.5 to 5.5, or a pH of 4.5 to 5.5. The pH may be adjusted using pH adjusters known in the art such as the exemplary pH adjusters mentioned above.

The synthesis of the ammoniated polycarbamide ends at a target viscosity on the Gardner-Holdt (G-H) bubble viscosity scale, including a viscosity of D to UV, a viscosity of K to P, a viscosity of FG, or a viscosity of GH. The target viscosity may be reached by adjusting the temperature and/or pH of the system. The pH of the system at the viscosity adjustment stage may be from 7 to 9, such as, for example, a pH of 7.2 to 8.4, or about 7.4 to 8.2, or about 7.5. The pH may be adjusted as known in the art using exemplary pH adjusters such as those mentioned above. After reaching the target viscosity, the system may be cooled to a temperature of from 50° C. to 90° C., from 50° C. to 70° C., from 55° C. to 65° C., or from 55° C. to 60° C.

Optionally, a second urea charge (U₂) is added during the synthesis of the ammoniated polycarbamide. The total urea (U) may include the first urea charge (U₁) plus the second urea charge (U₂), i.e., U=U₁+U₂. The batch temperature may be further cooled to a temperature of from 25° C. to 60° C., from 25° C. to 45° C., from 25° C. to 40° C., including approximately 20° C. to 25° C. The pH of the batch may likewise be adjusted as needed. The system may be held with continuous stirring for a time sufficient to dissolve the second urea, for example for from 30 to 60 minutes, from 5 to 30 minutes, or from 5 to 15 minutes.

Accordingly, an ammoniated polycarbamide useful in the invention is the reaction products of formaldehyde, urea, and ammonia. The molar ratio of formaldehyde to the combination of total urea and ammonia, i.e., [formaldehyde:(urea+ammonia)], [F/(U+A)], may range from 1 to 4, for example, from 1.1 to 3.9, from 1.2 to 3.8, from 1.3 to 3.7, from 1.4 to 3.6, or from 1.5 to 3.5. An ammoniated polycarbamide may also be adjusted to any desired degree of polymerization as is known in the art. The degree of polymerization can be adjusted by utilizing a different target end viscosity, a different F/(U+A) mole ratio, and/or a different manufacturing pH range.

Optionally, the synthesis process further includes the incorporation of one or more hydrophilic monomers that are polymerized during the synthesis of the ammoniated polycarbamide to form a hydrophilic polymer-modified ammoniated polycarbamide separation aid. Upon polymerization, the hydrophilic polymer may be included in the separation aid in an amount from 0.1 wt. % (weight percent) to 20 wt. %, based upon the total weight of the separation aid, such as, for example, from 0.05 wt. % to 18 wt. %, from 0.075 wt. % to 15 wt. %, from 0.1 wt. % to 12 wt. %, from 0.25 wt. % to 10 wt. %, from 0.5 wt. % to 8 wt. %, or from 1 wt. % to 6 wt. %, based upon the total weight of the separation aid. In some aspects, the hydrophilic polymer is included in the separation aid in an amount from 0.5 wt. % to 10 wt. %, based on the total weight of the separation aid.

The hydrophilic polymer comprises the reaction product of a hydrophilic monomer. In some aspects, the hydrophilic polymer is formed via radical polymerization of a hydrophilic monomer. Exemplary hydrophilic monomers include, without limitation, acrylamide monomers, acrylic acid, methacrylic acid, and the like. The hydrophilic monomer may comprise, or consist of, an acrylamide monomer. Exemplary hydrophilic polymers include, without limitation, N-methylolacrylamide polymer, poly(N,N-dimethylacrylamide), polyacrylamide, sodium polyacrylate, potassium polyacrylate, sodium polymethacrylate, potassium polymethacrylate, or combinations thereof. The hydrophilic polymer may comprise, or consist of, an acrylamide polymer. The hydrophilic polymer may comprise, or consist of, N-methylolacrylamide polymer

The method for adding a hydrophilic polymer to the ammoniated polycarbamide solution is not particularly limited. In certain aspects, the method includes adding hydrophilic monomer(s) to the reactor during formation of the ammoniated polycarbamide. For example, an acrylamide monomer (e.g., N-methylolacrylamide or nMA) may be added during the ammoniated polycarbamide synthesis process and mixed under acidic conditions. Upon incorporation of an initiator, the acrylamide monomer may undergo radical polymerization, forming the hydrophilic polymer (e.g., polynMA). The initiator may comprise any initiator commonly used in the art for radical polymerization, including peroxide or azo compounds. One exemplary initiator that would be suitable for use in the aforementioned reaction is ammonium persulfate. The initiator may be included in the liquid batch solution in an amount (solids) of about 0.001 wt. wt. %-2.0%, such as 0.01 wt. %-0.5 wt. %.

The incorporation of the hydrophilic polymer into the ammoniated polycarbamide solution improves the storage stability of the final polymer compound. The hydrophilic monomer may be added to the reactor at an elevated temperature and a pH in the range of 7 to 9, such as, for example, a pH of 7.2 to 8.4, or about 7.4 to 8.2, or about 7.5. The elevated temperature may range from 70° C.-95° C., or from 75° C.-90° C. and the composition may be mixed or otherwise agitated for 10 minutes to 60 minutes or 20 minutes to 50 minutes.

Optionally, the ammoniated polycarbamide separation aid may be further modified by a biopolymer or mixture of biopolymers. Thus, if present, the method of forming an ammoniated polycarbamide includes the addition of a biopolymer or a mixture of biopolymers to the ammoniated polycarbamide to form a biopolymer-modified ammoniated polycarbamide separation aid, or in some aspects, a biopolymer and hydrophilic polymer-modified ammoniated polycarbamide separation aid. The biopolymer may be included in the separation aid in an amount from 0.01 wt. % (weight percent) to 30 wt. %, based upon the total weight of the separation aid, such as, for example, from 0.05 wt. % to 25 wt. %, from 0.075 wt. % to 20 wt. %, from 0.1 wt. % to 18 wt. %, from 0.25 wt. % to 15 wt. %, from 0.5 wt. % to 12 wt. %, from 0.75 wt. % to 10 wt. %, from 0.9 wt. % to 8 wt. %, or from 1 wt. % to 5 wt. %, based upon the total weight of the separation aid.

The method for adding a biopolymer to the ammoniated polycarbamide solution is not particularly limited. For example, one or more biopolymer(s) may be added to the ammoniated polycarbamide during the synthesis process and mixed under neutral or alkaline conditions. The biopolymer may be dispersed in the polycarbamide solution and may incorporate within the polycarbamide via hydrogen bonding. Such an incorporation of the biopolymer into the polycarbamide improves the storage stability of the final polymer compound. The biopolymer may be added to the ammoniated polycarbamide at an elevated temperature and a pH in the range of 7 to 9, such as, for example, a pH of 7.2 to 8.4, or about 7.4 to 8.2, or about 7.5. The elevated temperature may range from 70° C.-95° C., or from 75° C.-90° C. and the composition may be mixed or otherwise agitated for 10 minutes to 60 minutes or 20 minutes to 50 minutes.

The biopolymer may comprise, or consist of lignin-based polymers, a polysaccharide, a starch, a hydrocolloid, or combinations thereof. The lignin-based polymers may comprise, for example a lignosulfonate, such as, for example, sodium lignosulfonate, calcium lignosulfonate, ammonium lignosulfonate, magnesium lignosulfonate, and the like. The hydrocolloid may comprise an anionic hydrocolloid, a nonionic hydrocolloid, or combinations thereof. Exemplary anionic hydrocolloids include, without limitation, sodium alginate (ALG), a xanthan gum (XG), carrageenan, high-methoxy pectin (HMOP), low-methoxy pectin (LMOP), and carboxymethyl cellulose (CMC). Exemplary nonionic hydrocolloids include, without limitation, arabic gum (AG), a guar gum, locust bean gum, konjac glucomannan, and hydroxypropyl methyl cellulose (HPMC).

The biopolymer may comprise, or consist of a starch, carboxymethylcellulose (CMC), a guar gum, a xanthan gum, flour, a soy protein, or combinations thereof. The starch may be a natural starch and/or a modified starch. Exemplary natural starches include, without limitation, corn starch, potato starch, tapioca starch, arrowroot, and wheat rice. Exemplary modified starches include, without limitation, a cationic starch, an anionic starch, a zwitterionic starch, and a carboxylated starch. Exemplary guar gums include, without limitation, a natural guar gum, a cationic guar gum, and an anionic guar gum. Exemplary xanthan gums include, without limitation, a natural xanthan gum, a cationic xanthan gum, and an anionic xanthan gum. The flour may comprise a natural flour, a cationic flour, or combinations thereof. The soy protein may comprise a natural soy protein, a cationic soy protein, an anionic soy protein, or combinations thereof.

### Sulfur Compound

A separation aid of the invention may further optionally include a sulfur compound. Accordingly, the separation aid may comprise, consist essentially of, or consist of the ammoniated polycarbamide (optionally modified with a biopolymer and/or a hydrophilic polymer) and a sulfur compound. The sulfur compound may serve as a performance enhancing supplement to the ammoniated polycarbamide, i.e., both to improve the stability of the ammoniated polycarbamide, and to improve the depression of copper or other minerals in the disclosed methods.

The sulfur compound may comprise an organic or inorganic sulfur compound. The sulfur compound may comprise a compound having an ionizable thiol group. The sulfur compound may comprise, or consist of, a sulfite, a sulfate, a thiol-functional compound, a sulfide, a sulfamate, a sulfinic acid, or combinations thereof. The sulfur compound may comprise, or consist of, a sulfide, a disulfide, a sulfinic ester, a thiocyanate, a thiocarboxylic acid, a thioester, a sulfinic acid, a dithiocarboxylic acid, a dithiocarboxylic acid ester, a sulfamate, a sulfamide, salts of any of the above, or combinations thereof. The sulfur compound may comprise, or consist of, sodium metabisulfite, sodium bisulfite, sodium sulfite, sodium thiosulfate, thiourea, thiourea-formaldehyde polymer, sodium thiocyanate, sodium thiocarboxylate, methanethiol, ethanethiol, 2-mercaptoethanol, dimercaptosuccinic acid, cysteine, sodium sulfide, ammonium sulfide, sodium sulfamate, ammonium sulfamate, sodium sulfinate, or combinations thereof. In one aspect the sulfur compound is sodium metabisulfite, a thiourea-formaldehyde polymer, or a mixture thereof. In other aspects, the sulfur compound may comprise, or consist of, a thiourea derivative selected from the group consisting of cyclohexyl thiourea, phenylthiourea, and N-allylthiourea.

The sulfur compound may be included in the separation aid in an amount from 0.1 wt. % to 50 wt. %, based upon the total weight of the separation aid, including an amount from 0.1 wt. % to 40 wt. %, from 0.1 wt. % to 30 wt. %, from 0.5 wt. % to 30 wt. %, and from 0.2 wt. % to 10 wt. %, based upon the total weight of the separation aid.

### Supplemental Depressants

A separation aid of the invention may also contain one or more supplemental depressants, which act or aid to disperse a particular mineral. In particular, the supplemental depressants aid in depressing certain minerals, such as copper and/or iron, during a flotation process to further separate such materials from those to be collected at the top of a separation vessel as part of the froth. The depressants are hydrophilic in nature and come into contact with the hydrophobic target minerals, such as copper. The copper-depressant complex that forms is now more hydrophilic than the original copper mineral. This hydrophilicity causes the surface-modified copper to remain in the aqueous pulp instead of attaching to hydrophobic bubbles, so the copper is depressed or settles out under the influence of gravity rather than floating to the top after attachment to a bubble.

Accordingly, a separation aid of the invention may comprise, consist essentially of, or consist of an ammoniated polycarbamide (optionally modified with a biopolymer and/or a hydrophilic polymer), an optional sulfur compound, and a supplemental depressant. Accordingly, a method for the separation and recovery of one or more minerals from a mineral ore bulk material may include the steps of pre-mixing an ammoniated polycarbamide and one or more supplemental depressants to form a separation aid, followed by adding the separation aid to the aqueous pulp. Alternatively, or in addition to adding the supplemental depressant in a second step, the supplemental depressant may be incorporated during the formation of the ammoniated polycarbamide, forming a one-part system.

A supplemental depressant or mixture of supplemental depressants may be included in a separation aid in an amount from 0.1 wt. % to 50 wt. %, based upon the total weight of the separation aid, such as from 0.5 wt. % to 40 wt. %, from 0.8 wt. % to 30 wt. %, from 0.8 wt. % to 25 wt. %, from 0.2 wt. % to 10 wt. %, from 0.5 wt. % to 8 wt. %, including from 1 wt. % to 6 wt. %.

Exemplary supplemental depressants include, without limitation, thioglycolic acid (TGA) salts, ethylenediaminetetraacetic acid (EDTA) salts, mercaptosuccinic acid (MSA) salts, thioglycerin (TG) salts, or combinations thereof. The supplemental depressants are formed by neutralizing thioglycolic acid, ethylenediaminetetraacetic acid, mercaptosuccinic acid, or thioglycerin with a base or an amine to form sodium, calcium, amine, or ammonium salts. Exemplary bases include sodium hydroxide (NaOH) and calcium hydroxide (Ca(OH)₂) and exemplary amines include amines, diamines, triamines, and tetramines, including diethylenetriamine (DETA) and ammonia. The supplemental depressants may be in a solid or aqueous form.

The supplemental depressants may comprise, or consist of, a thioglycolic acid (TGA) salt. The thioglycolic acid (TGA) salt may be an alkali metal TGA salt, an alkaline earth metal TGA salt, or an amine TGA salt. An amine thioglycolic acid (TGA) salt may be selected from the group consisting of amine-, diamine-, triamine-, and tetraamine-TGA salts, or combinations thereof. The thioglycolic acid (TGA) salt may be selected from the group consisting of mono- or di-sodium thioglycolate (S-TGA), calcium thioglycolate (C-TGA), diethylenetriamine thioglycolate (D-TGA), ammonium thioglycolate (A-TGA), or combinations thereof. The supplemental depressant may comprise, or consist of, an aminopolycarboxylic acid salt, as aminopolycarboxylic acid can form complexes with metal ions including, but not limited to, copper, iron, cobalt, and the like. The aminopolycarboxylic acid salt may be selected from the group consisting of ethylenediaminetetraacetic acid (EDTA) salts, diethylenetriaminepentaacetic acid (DTPA) salts, nitrilotriacetic acid (NTA) salts, iminodiacetic acid (IDA) salts, or combinations thereof. The supplemental depressant may comprise, or consist of, mono- or di-sodium EDTA (S-EDTA). The supplemental depressant may comprise, or consist of, mono- or di-sodium mercaptosuccinate (S-MSA), mono- or di-sodium thioglycerolate (S-TG), or combinations thereof. The supplemental depressant may also be one or more conventional depressants, such as, for example, sodium hydrosulfide (NaSH), sodium sulfide (Na₂S), Nokes reagent, sodium cyanide (NaCN), or combinations thereof. In some aspects, the supplemental depressants may include a thiourea-formaldehyde polymer formed from a reaction of thiourea and free formaldehyde.

A method for the separation and recovery of one or more minerals from a mineral ore bulk material may include preparing the supplemental depressant prior to mixing the ammoniated polycarbamide and the supplemental depressant. The preparation of the supplemental depressant may comprise any known synthesis method.

The ammoniated polycarbamide of the invention (including any optional supplemental depressants) may be used in a mining flotation process in a dosage amount from 0.5 kg/T to 15 kg/T, based on the total weight of mineral ore bulk material (in tones “T”), including, for example, a dosage amount from 0.7 kg/T to 10 kg/T, or from 0.9 kg/T to 9 kg/T, or from 1 kg/T to 7 kg/T, or from 1.5 kg/T to 5.5 kg/T, including all endpoints and subranges therebetween. Preferably, the ammoniated polycarbamide separating agent includes less than 5 kg/T of NaSH, such as, for example, less than 3 kg/T, less than 2.5 kg/T, less than 2 kg/T, less than 1.5 kg/T, or less than 1 kg/T NaSH.

The ammoniated polycarbamide separation aid reduces, or eliminates, the use of conventional separation aid depressants such as NaSH, Na₂S, Nokes reagent, and NaCN in mining flotation processes, including copper-molybdenum separations. Accordingly, in some aspects, the separation aid is devoid of NaSH, Na₂S, Nokes reagent, and NaCN. In some aspects, the separation aid is devoid of NaSH.

Thus, a method is provided for depressing certain minerals, such as copper and iron, in mining flotation processes with an ammoniated polycarbamide separation aid that reduces, or eliminates, the use of conventional hazardous reagents such as NaSH. NaSH produces hydrogen sulfide gas upon decomposition, which is highly toxic, flammable, corrosive, and malodorous. In contrast, the ammoniated polycarbamide separation aid produces no gas and is not corrosive, thus allowing safer industrial handling.

The biopolymer ingredients of the inventive composition provide a sustainable alternative to the conventional use of NaSH. The biopolymer materials, if present, including, inter alia, starch and carboxymethylcellulose (CMC), are considered “natural” and the hydrophilic polymer materials if present, are environmentally friendly, and thus alleviate the concerns associated with conventional hazardous inorganic depressants.

Further, NaSH and other conventional inorganic depressants are oxidized and rendered ineffective when air is used to generate bubbles during the flotation process, causing mines to either use higher amounts of NaSH to compensate for the loss of efficacy due to oxidation, or else to use nitrogen gas to substantially reduce the oxidation of NaSH during flotation separation. However, the use of nitrogen gas adds cost to a flotation process and has been found to only minimally reduce NaSH (or other inorganic depressant) consumption. In contrast, the ammoniated polycarbamide separation aid of the invention is not readily oxidized by air, and thus there is no need to use nitrogen gas to generate bubbles during the flotation process. This provides both manufacturing efficiencies, as well as cost reductions. Additionally, the ammoniated polycarbamide separation aid operates effectively across a pH range of 8 to 14, which increases the flexibility in flotation circuit conditions, compared to NaSH, which requires a narrow pH range (about 10.5-12.5) to maintain effectiveness.

It was surprisingly found that the biopolymer and/or hydrophilic polymer components change the rheology of the ammoniated polycarbamide and improve the depression of copper and other minerals in a flotation mining process. This improved depression results in less copper recovery at the surface of the flotation cell.

The floated mineral concentrate recovery of the inventive method is the same or similar to, or improved compared to that of an otherwise identical method that uses NaSH as a sole separation aid. In some aspects, the flotation tailings recovery of the inventive method is the same or similar to that of an otherwise identical method that uses NaSH as a sole separation aid. By providing equal or better depression of minerals, such as copper, at much lower ammoniated polycarbamide separation aid treatment levels than conventional NaSH separation aids, the disclosed methods thus provide substantial economic benefits.

Unexpectedly, the ammoniated polycarbamide separation aid provides high recovery rates of molybdenum and is at least comparable, if not improved, over the molybdenum recovery rates achieved through the use of NaSH. Percent recovery is defined as the total amount of molybdenum recovered after the flotation process (froth) divided by the total amount of molybdenum present in the mineral concentrate prior to the flotation process. The percent recovery of molybdenum is at least about 50%, at least about 55%, at least about 60%, at least about 65%, at least about 70%, at least about 75%, at least about 77%, at least about 80%, at least about 85%, or at least about 90%.

Additionally, the use of the ammoniated polycarbamide separation aid selectively removes molybdenum from the mineral concentrate without also recovering significant quantities of unwanted minerals, such as copper and iron. For instance, the percent recovery of copper as a contaminant in the molybdenum is less than about 10%, including, for example, 8% or less, 7% or less, 6% or less, 5.5% or less, 5% or less, and 4.5% or less. In some instances, the percent recovery of copper is between 1-3%. As above, the percent recovery is the total amount of copper recovered after the flotation process (froth) divided by the total amount of copper present in the mineral concentrate prior to the flotation process.

In sum, as described, the invention relates the advantageous use of an ammoniated polycarbamide as a separation aid in a mineral ore separation process.

### EXAMPLES

The following examples are included for the purposes of illustration, and do not limit the scope of the general inventive concepts described herein.

Ammoniated Polycarbamide with Sulfur Compound

### Example 1—Preparation of Ammoniated Polycarbamide Separation Aids

Exemplary separation aids are prepared by synthesizing sulfur-containing, ammoniated polycarbamide using a two-stage polymer process. The first stage forms the ammoniated polycarbamide (steps 1 and 2), and the second stage modifies the ammoniated polycarbamide with a sulfur compound as a performance enhancing supplement (steps 3 and 4).

In step 1, formaldehyde is charged into a reactor and the pH is adjusted to 7.0-9.0, preferably 7.5-8.5. Aqueous formaldehyde (53% concentration) is used for the polymer synthesis. Alternatively, urea-formaldehyde concentrate (UFC) may be used for polymer synthesis. An exemplary UFC is composed of 60 wt. % formaldehyde, 25 wt. % urea, and 15 wt. % water. The pH adjusters include triethanolamine (TEA) and 50% NaOH, as well as optionally 6% sulfuric acid, or 10% formic acid, as needed. A solution of 30% aqueous ammonia is then added to the mixture. Optionally, a small quantity of sodium metabisulfite (SMBS) is charged to the batch to improve the stability and solubility of the polymer, as needed. Thereafter, a first urea charge (U₁) is added to the reactor, and the temperature is increased to 90° C.-107° C., preferably 95° C.-102° C. The batch is held at this temperature for 30-60 minutes, preferably for 40-50 minutes. The F/U₁ [i.e., formaldehyde:urea] mole ratio is from 1.5-4.0, preferably from 2.0-3.5. The F/(U₁+A) [i.e., formaldehyde:(urea+ammonia) mole ratio is from 1.0-4.0, preferably from 1.5-3.5. The urea and formaldehyde are reacted near neutral, at a pH range of 7.0-9.0, preferably 7.5-8.5, to form various hydroxymethylureas (i.e., UF methylolation). The ammonia and formaldehyde are reacted near neutral, at a pH range of 7.0-9.0, preferably 7.5-8.5, to form various hydroxymethylammonias (i.e., AF methylolation). Thereafter, the methylol ammonia and urea are reacted near neutral pH to form triazones and its derivatives (i.e., UFA ammoniation).

In step 2, the pH is decreased to an acidic range of 3.0-6.0, preferably 3.5-5.5. The pH adjusters include acidic pH adjusters, such as 6% sulfuric acid, formic acid, and/or triethanolamine (TEA), as needed. The second step is ended at a target Gardner-Holdt (G-H) bubble viscosity of “D-UV” (preferably, “F-P”), which is achieved via increasing the pH to 7.0-9.0, preferably 7.5-8.5, using TEA and 50% NaOH as the pH adjusters. After reaching the target viscosity, vacuum cooling or cooling water is applied to lower the temperature of the batch to 85° C.-90° C. A water charge is employed at this step to adjust the solids content and the viscosity of the batch to the desired range.

The second stage includes the addition of a sulfur compound to the ammoniated polycarbamide in steps 3 and 4 thereby forming a sulfur-containing, ammoniated polycarbamide separation aid.

In step 3, sulfur compounds are utilized as performance-enhancing supplements. The exemplary types of sulfur compounds include sodium metabisulfite (SMBS), a thiourea-formaldehyde polymer, and combinations of thereof. The level of sulfur compound may be varied from 0.1 wt. %-40 wt. %. In samples comprising sodium metabisulfite as the sulfur compound, sodium metabisulfite is added to the batch at 60° C.-65° C. Mixing is continued for 5-60 minutes, preferably 15-40 minutes, at 60° C.-75° C., preferably 65° C.-70° C. The batch pH at this step is maintained at 7.0-9.0, preferably 7.5-8.5.

In samples comprising a thiourea-formaldehyde polymer as the sulfur compound, the thiourea-formaldehyde polymer may be synthesized as follows. 53% formaldehyde (F₁) is charged into the batch and the pH is adjusted to 7.0-9.0, preferably 7.5-8.5, using TEA, 50% NaOH, and optionally 6% sulfuric acid and/or formic acid as the pH adjusters. Thiourea (T) is then added, and the pH is readjusted to 7.0-9.0, preferably 7.5-8.5 as needed. The batch is maintained at 50° C.-75° C., preferably 55° C.-70° C., for 10-60 minutes, preferably 20-50 minutes, and the thiourea-formaldehyde polymer is formed from the reaction between formaldehyde (F₁) and thiourea (T). The (F+F₁)/(U₁+A+T) [i.e., total formaldehyde:(urea+ammonia+thiourea)] mole ratio is from 1.0-3.5, preferably from 1.5-3.0.

In step 4, the reaction mixture is cooled to 50° C.-70° C., preferably 55° C.-65° C., and the second urea (U₂) is added to the reactor. The batch temperature is held at 40° C.-60° C., preferably 45° C.-55° C. for 5-60 minutes, preferably 15-45 minutes. The pH was adjusted to 7.0-9.5, preferably 7.5-9.0, using TEA and 6% sulfuric acid. The final (total F)/(total U+A), or (F+F₁)/(U₁+A+T+U₂) mole ratio is from 0.5-2.5, preferably 0.8-2.0. The process for manufacturing the sulfur-containing, ammoniated polycarbamide with performance-enhancing supplements is completed by cooling the batch to 20° C.-25° C.

A summary of the synthesis process of Example 1 is provided below in Table 1.

TABLE 1
Synthesis of Exemplary Polycarbamide Separation Aids with Sulfur Compounds

| Compound A1 | | Compound A2, Compound A3, Compound A4 | |
|---|---|---|---|
| Stage 1, Step 1: | | Stage 1, Step 1: | |
| 1) | Charge 53% Formaldehyde. | 1) | Charge 53% Formaldehyde. |
| 2) | Adjust pH to 7.5 ± 0.5 with TEA and 50% | 2) | Adjust pH to 7.5 ± 0.5 with TEA and 50% |
| | NaOH. | | NaOH. |
| 3) | Charge SMBS. | 3) | Charge SMBS. |
| 4) | Charge aqua ammonia and urea (U1). | 4) | Charge aqua ammonia and urea (U1). |
| 5) | Heat to 99° C.-102° C. and hold for 30-45 | 5) | Heat to 99° C.-102° C. and hold for 30-45 |
| | minutes or until pH stabilizes. | | minutes or until pH stabilizes. |
| Stage 1, Step 2: | | Stage 1, Step 2: | |
| 6) | Adjust pH to 4.7 ± 0.1 with 6% sulfuric acid. | 6) | Adjust pH to 4.6 ± 0.1 with 6% sulfuric acid. |
| 7) | Cook to a target “FG” (Gardner-Holdt bubble | 7) | Cook to a target “GH” (Gardner-Holdt bubble |
| | viscometer) at 95° C.-100° C. | | viscometer) at 95° C.-100° C. |
| 8) | Adjust pH to 7.5-8.0 with 50% NaOH while | 8) | Adjust pH to 7.5-8.0 with 50% NaOH while |
| | cooling to 85° C.-90° C. | | cooling to 85° C.-90° C. |
| Stage 2, Step 3: | | Stage 2, Step 3: | |
| 9) | Charge water and cool the batch to 60° C. | 9) | Charge water and cool the batch to 60° C. |
| 10) | Charge SMBS. | 10) | Charge SMBS. |
| 11) | Mix for 30 minutes at 70° C. | 11) | Mix for 30 minutes at 70° C. |
| Stage 2, Step 4: | | 12) | Charge 53% formaldehyde and adjust pH to |
| 12) | Cool the batch to 60° C. | | 7.5-8.0 with 50% NaOH. |
| 13) | Charge urea (U2) and hold for 10 minutes at | 13) | Charge thiourea and cook for 30 minutes at |
| | 45° C. | | 60° C. at pH 8.0 ± 0.5. |
| 14) | Cool the batch to 25° C. and adjust pH to | Stage 2, Step 4: | |
| | 8.0 ± 0.5 with either TEA or 10% formic | 14) | Charge urea (U2) and hold for 10 minutes at |
| | acid. | | 45° C. |
| | | 15) | Cool the batch to 25° C. and adjust pH to |
| | | | 8.0 ± 0.5 with either TEA or 10% formic |
| | | | acid. |

The chemical composition of each ammoniated polycarbamide separation aid, compounds A1-A4, is shown in Table 2.

TABLE 2
Chemical Composition of Ammoniated Polycarbamide
Separation Aids (wt. %)

| | Com- | Com- | Com- | Com- |
|---|---|---|---|---|
| | pound | pound | pound | pound |
| Composition | A1 | A2 | A3 | A4 |
| HCHO (53%)¹ | 44.00 | 35.50 | 35.50 | 41.00 |
| TEA² | 0.10 | 0.10 | 0.10 | 0.10 |
| 50% NaOH | 0.04 | 0.05 | 0.05 | 0.04 |
| SMBS³ | 0.80 | 0.80 | 0.80 | 0.80 |
| Aqua Ammonia⁴ | 4.50 | 4.00 | 4.00 | 4.50 |
| Urea | 17.00 | 13.30 | 13.30 | 15.50 |
| 6% sulfuric acid | 0.30 | 0.40 | 0.40 | 0.30 |
| 50% NaOH | 0.10 | 0.10 | 0.10 | 0.10 |
| Water | 9.00 | 13.75 | 9.75 | 8.16 |
| SMBS³ | 7.00 | 5.00 | 5.00 | 6.00 |
| HCHO (53%)¹ | 0.00 | 8.00 | 8.00 | 4.00 |
| Thiourea | 0.00 | 10.00 | 10.00 | 5.00 |
| Urea | 17.16 | 9.00 | 13.00 | 14.50 |
| Total [wt. %] | 100.00 | 100.00 | 100.00 | 100.00 |

¹= 53% concentration aqueous formaldehyde,
²= Triethanolamine,
³= sodium metabisulfite,
⁴= 28% aqueous ammonia

The ammoniated polycarbamide separation aids were thereafter examined for pH, solids, viscosity, color, and stability at both 4° C. and 20° C.-25° C. storage, as summarized in Table 3. Each of the exemplary ammoniated polycarbamide separation aids demonstrate very good storage stability at 20° C.-25° C., as well as 4° C. storage stability, without any phase separation or precipitation.

TABLE 3
Characteristics of Exemplary Ammoniated polycarbamide
Separation Aids with Sulfur Compounds

| | | solids | Viscosity | | 4° C. | 20° C.-25° |
|---|---|---|---|---|---|---|
| | pH | (%) | (cP) | color | stability | C. stability |
| Compound A1 | 8.8 | 58 | 39 | clear | ~3 months | ~2 months |
| Compound A2 | 8.6 | 55 | 27 | clear | ~3 months | ~2 months |
| Compound A3 | 8.2 | 59 | 27 | clear | ~3 months | ~2 months |
| Compound A4 | 8.7 | 58 | 39 | clear | ~3 months | ~2 months |

### Example 2—Flotation Tests

Lab-scale flotation tests were conducted using ammoniated polycarbamides with sulfur compounds, Compounds A1-A4, as described in Example 1. The tests were conducted using a Metso D-12V flotation machine (manufactured by Metso Minerals Industries, Inc.). The minerals (Cu, Mo) from the floated concentrates as well as the tailing were measured by XRF (X-Ray Fluorescence) analyzer (manufactured by Thermo Scientific Niton XL3t GOLDD+). The Cu—Mo bulk concentrate was obtained from a copper mine in Arizona in the United States. The Cu—Mo concentrate contained typical industry levels of Cu and Mo, which are around 20% to 30% copper and 0.2% to 1.0% molybdenum. The ammoniated polycarbamides were employed with or without supplemental depressants for the flotation tests. When the ammoniated polycarbamides were employed with supplemental depressants for the flotation study, the ammoniated polycarbamides and the supplemental depressants may be added separately, or they may be pre-mixed prior to the test and added as a one-part system.

The lab-scale flotation cell test was conducted according to the following procedure: (1) thaw 500 g of ore sample (Cu—Mo concentrate) in a warm water bath; (2) transfer the Cu—Mo bulk concentrate to a flotation cell; (3) start the impeller and adjust the speed to 900 rpm; (4) control the pulp (Cu—Mo concentrate) level to be just below the target (not to overflow before the air) and mix the slurry; (5) check the pulp pH and ORP (Oxidation-Reduction Potential) prior to the addition of chemicals (control NaSH or exemplary ammoniated polycarbamides); (6) slowly add chemicals to the flotation cell (e.g., control NaSH: ˜550 mV ORP for full Cu depression); (7) add diesel as Mo collector if needed; (8) start and adjust air to the target flow rate (2 L/min or as needed); (9) float concentration 1 (first scrape of float bubbles) for 2 min in a collection pan (concentration 1) and measure the weight of the concentration 1 before the vacuum dry (mass pull 1); (10) record pH and ORP; (11) replace the collection pan and float concentration 2 for 3 min in a collection pan (concentration 2) and measure the weight of the concentration 2 before the vacuum dry (mass pull 2); and (12) record pH and ORP.

The XRF (X-Ray Fluorescence) measurement was conducted according to the following procedure: (1) vacuum-dry concentration 1 (float concentration 1) and concentration 2 (float concentration 2), as well as the tailing (depressed mineral), and measure the weight of each material (i.e., the total mineral concentrate is the sum of vacuum-dried conc 1, vacuum-dried concentration 2, and vacuum-dried tailing); (2) oven-dry the materials overnight at 125° C., and measure the weight of each material; (3) measure and analyze the minerals from each material, and select Cu, Mo, Fe amounts on the XRF device; and (4) analyze Cu, Mo, Fe concentrations and obtain the recovery and grade of these minerals.

The results of the lab-scale flotation cell tests are summarized in Tables 4-6.

TABLE 4
Flotation Cell Test Results (Study #1)

| | Study #1 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 6.0 | 6.0 | 5.0 | 85.3 | 22.8 | 6.7 |
| Sample 1 | Compound A2 | — | 0.5 | — | 0.5 | 6.5 | 67.2 | 24.3 | 4.9 |
| Sample 2 | Compound A2 | NaSH | 0.5 | 2.0 | 2.5 | 6.5 | 61.6 | 24.1 | 4.7 |
| Sample 3 | Compound A3 | NaSH | 0.5 | 2.0 | 2.5 | 5.0 | 67.1 | 23.4 | 5.9 |
| Sample 4 | Compound A4 | NaSH | 0.5 | 2.0 | 2.5 | 4.2 | 70.1 | 23.0 | 6.4 |
| Sample 5 | Compound A1 | NaSH | 0.5 | 2.0 | 2.5 | 6.0 | 70.6 | 23.7 | 5.4 |
| Sample 7 | Compound A3 | S-TGA | 0.5 | 1.5 | 2.0 | 3.6 | 63.9 | 22.7 | 6.9 |
| Sample 8 | Compound A1 | S-TGA | 0.5 | 1.5 | 2.0 | 2.5 | 53.1 | 21.9 | 6.8 |

TABLE 5
Flotation Cell Test Results (Study #2)

| | Study #2 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 5.0 | 5.0 | 7.1 | 81.4 | 23.3 | 5.5 |
| Sample 9 | Compound A2 | S-TGA | 0.5 | 1.5 | 2.0 | 5.7 | 81.0 | 22.7 | 5.8 |
| Sample 10 | — | S-TG | — | 2.0 | 2.0 | 15.7 | 72.3 | 25.8 | 2.8 |
| Sample 11 | Compound A2 | S-MSA | 0.5 | 1.0 | 1.5 | 5.8 | 56.7 | 23.7 | 4.7 |

TABLE 6
Flotation Cell Test Results (Study #3

| | Study #3 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 6.0 | 6.0 | 4.9 | 74.6 | 23.0 | 5.9 |
| Sample 12 | Compound A2 | NaSH | 0.6 | 2.4 | 3.0 | 4.1 | 73.1 | 22.8 | 5.8 |

Overall, as detailed in Tables 4-6, the sulfur-containing, ammoniated polycarbamide compositions described herein, with and without supplemental depressants, provided similar recovery of Cu and Mo as the control NaSH, and reduced or replaced NaSH at much lower chemical treatment levels. For example, the sulfur containing, ammoniated polycarbamide composition and S-TGA supplemental depressant (Sample 9, Compound A2 with S-TGA) demonstrated better Cu depression (lower Cu recovery value) and similar Mo recovery (good Cu—Mo separation) than the control NaSH at 60% total reduced chemical treatment level (than the control NaSH) and was able to replace 100% NaSH. The sulfur-containing, ammoniated polycarbamide composition (Sample 1, Compound A2) showed comparable Cu—Mo recovery data as the control NaSH at 91.7% total reduced chemical treatment level than the control NaSH (0.5 kg/T Compound A2 vs. 6 kg/T NaSH) and was able to replace 100% NaSH. The ammoniated polycarbamide composition (Sample 7, Compound A3 with S-TGA and Sample 8, Compound A1 with S-TGA) demonstrated comparable Cu—Mo recovery data as the control NaSH at lower total chemical treatment levels (than control NaSH level) and exhibited a 100% NaSH replacement option. The ammoniated polycarbamide composition (Sample 12) showed the similar Cu—Mo recovery values as the control NaSH at a lower total chemical treatment level (than the control NaSH) and was able to reduce NaSH level to 60%.

### Example 3—Preparation of a Biopolymer-Modified Ammoniated Polycarbamide Separation Aid

### Example 3(a)

Exemplary separation aids are prepared by synthesizing biopolymer-modified ammoniated polycarbamide using a two-stage polymer process. The first stage forms the ammoniated polycarbamide (steps 1 and 2), and the second stage modifies the ammoniated polycarbamide with a biopolymer (steps 3 and 4).

In step 1, formaldehyde is charged into a reactor and the pH is adjusted to 7.0-9.0, preferably 7.5-8.5. Aqueous formaldehyde (53% concentration) is used for the polymer synthesis. Alternatively, urea-formaldehyde concentrate (UFC) may be used for the polymer synthesis. An exemplary UFC is composed of 60 wt. % formaldehyde, 25 wt. % urea, and 15 wt. % water. The pH adjusters include triethanolamine (TEA) and 50% NaOH, as well as optionally 6% sulfuric acid, or 10% formic acid, as needed. A solution of 30% aqueous ammonia is then added to the mixture. Optionally, a small quantity of sodium metabisulfite (SMBS) is charged to the batch to improve the stability and solubility of the polymer, as needed. Thereafter, a first urea charge (U₁) is added to the reactor, and the temperature is increased to 90° C.-107° C., preferably 95° C.-102° C. The batch is held at this temperature for 30-60 minutes, preferably for 40-50 minutes. The F/U₁ [i.e., formaldehyde:urea] mole ratio is from 1.5-4.0, preferably from 2.0-3.5. The F/(U₁+A) [i.e., formaldehyde:(urea+ammonia) mole ratio is from 1.0-4.0, preferably from 1.5-3.5. The urea and formaldehyde are reacted near neutral, at a pH range of 7.0-9.0, preferably 7.5-8.5, to form various hydroxymethylureas (i.e., UF methylolation). The ammonia and formaldehyde are reacted near neutral, at a pH range of 7.0-9.0, preferably 7.5-8.5, to form various hydroxymethylammonias (i.e., AF methylolation). Thereafter, the methylol ammonia and urea are reacted near neutral pH to form triazones and its derivatives (i.e., UFA ammoniation).

In step 2, the pH is decreased to an acidic range of 3.0-6.0, preferably 3.5-5.5. The pH adjusters include acidic pH adjusters, such as 6% sulfuric acid, formic acid, and/or triethanolamine (TEA), as needed. The second step is ended at a target Gardner-Holdt (G-H) bubble viscosity of “D-UV” (preferably, “F-G”, which is achieved via increasing the pH to 7.0-9.0, preferably 7.5-8.5, using TEA and 50% NaOH as the pH adjusters. After reaching the target viscosity, vacuum cooling or cooling water is applied to lower the temperature of the batch to 85° C.-90° C. A water charge is employed at this step to adjust the solids content and the viscosity of the batch to the desired range.

The second stage includes the addition of a biopolymer (e.g., starch) to the ammoniated polycarbamide in steps 3 and 4 thereby forming a biopolymer-modified ammoniated polycarbamide separation aid.

In step 3, the ammoniated polycarbamide product of step 2 is cooled to a temperature of 70° C.-95° C., preferably 75° C.-90° C., and a premixture of starch and water is added to the reactor. At this step, starch is dispersed first in the polycarbamide solution and de-natured (or untangled), which causes the starch to swell. The batch temperature is held for 5-60 minutes, preferably 15-50 minutes. The starch level ranges from 0.01 wt. %-10 wt. % %, preferably from 0.1 wt. %-4 wt. % %. The pH at this step is 7.0-9.0, preferably 7.5-8.5. After reaching the target viscosity, vacuum cooling or cooling water was applied to lower the temperature of the batch to 60° C.-65° C. A water charge is employed at this step to adjust the solids content and the viscosity of the batch to the desired range.

In step 4, the batch is cooled to a temperature of 50° C.-70° C., preferably 55° C.-65° C., and the second urea (U₂) is added to the reactor. The batch temperature is then further reduced to a temperature of 40° C.-60° C., preferably 45° C.-55° C. and held for 5-60 minutes, preferably 15-45 minutes. The pH is adjusted to 7.0-9.5, preferably 7.5-9.0, using TEA and 6% sulfuric acid and/or 10% formic acid. The final (total F)/(total U+A), or F/(U₁+A+U₂) mole ratio was from 0.5-2.5, preferably 0.8-2.0. The process for manufacturing the biopolymer-modified ammoniated polycarbamide was completed by cooling the batch to 20° C.-25° C.

A summary of the synthesis process of Example 3 (a) is provided below in Table 7 (a).

TABLE 7(a)
Synthesis of Exemplary Biopolymer-Modified Ammoniated Polycarbamides

| Compound A5 | | Compound A6 | |
|---|---|---|---|
| Stage 1, Step 1: | | Stage 1, Step 1: | |
| 1) | Charge 53% Formaldehyde. | 1) | Charge 53% Formaldehyde. |
| 2) | Adjust pH to 7.5 ± 0.5 with TEA | 2) | Adjust pH to 7.5 ± 0.5 with TEA |
| | (triethanolamine) and 50% NaOH. | | and 50% NaOH. |
| 3) | Charge aqua ammonia and urea (U1). | 3) | Charge aqua ammonia and urea. |
| 4) | Heat to 99° C.-102° C. and hold for | 4) | Heat to 99° C.-102° C. and hold for 30-45 |
| | 30-45 minutes or until pH stabilizes. | | minutes or until pH stabilizes. |
| Stage 1, Step 2: | | Stage 1, Step 2: | |
| 5) | Adjust pH to 4.8 ± 0.1 with 6% sulfuric acid. | 5) | Adjust pH to 4.8 ± 0.1 with 6% sulfuric acid. |
| 6) | Cook to a target “F” (Gardner-Holdt bubble | 6) | Cook to a target “F” (Gardner-Holdt bubble |
| | viscometer) at 95° C.-100° C. | | viscometer) at 95° C.-100° C. |
| 7) | Adjust pH to 7.5-8.0 with 50% NaOH while | 7) | Adjust pH to 7.5-8.0 with 50% NaOH while |
| | cooling to 85° C.-90° C. | | cooling to 85° C.-90° C. |
| Stage 2, Step 3: | | Stage 2, Step 3: | |
| 8) | Charge a premix of starch and water. | 8) | Charge water. |
| 9) | Cook for 30 minutes at 85° C. | 9) | Charge a premix of starch and water. |
| 10) | Charge water and cool to 60° C.-65° C. | 10) | Cook for 30 minutes at 85° C. |
| Stage 2, Step 4: | | 11) | Cool the batch to 60° C. |
| 11) | Cool the batch to 50° C.-65° C. and charge | Stage 2, Step 4: | |
| | urea (U2). | 12) | Charge urea and hold for 10 minutes at 45° C. |
| 12) | Reduce temperature to 45° C.-60° C. and | 13) | Cool the batch to 25° C. and adjust pH to |
| | hold for 15 minutes. | | 8.0 ± 0.5 with either TEA or 10% formic |
| 13) | Adjust pH to 7.5-9.0 with TEA and 6% | | acid. |
| | sulfuric acid. | | |
| 14) | Cool the batch to 25° C. and adjust pH to | | |
| | 8.0 ± 0.5 with either TEA or 10% formic | | |
| | acid. | | |

### Example 3(b)

A biopolymer-modified ammoniated polycarbamide is synthesized using a three-stage polymer process. The first stage forms the ammoniated polycarbamide (steps 1 and 2), the second stage modifies the ammoniated polycarbamide with a biopolymer (step 3), and the third stage introduces a sulfur compound in the third stage (including steps 5 and 6).

The first stage includes the formation of the ammoniated polycarbamide as outlined in steps 1 and 2 of Example 3 (a). The second stage constitutes the modification of the ammoniated polycarbamide with a biopolymer, e.g., starch, as outlined in step 3 of Example 3 (a).

The third stage constitutes the addition of the sulfur compound to the biopolymer-modified ammoniated polycarbamide in steps 4 and 5.

In step 4, sulfur compounds are utilized as performance-enhancing supplements. The exemplary types of sulfur compounds include sodium metabisulfite, a thiourea-formaldehyde polymer, and combinations of thereof. The level of sulfur compound is varied from 0.1 wt. %-40 wt. %. In samples comprising sodium metabisulfite as the sulfur compound, sodium metabisulfite is added to the batch at 65° C.-75° C. Mixing is continued for 5-60 minutes, preferably 15-40 minutes, at 65° C.-75° C., preferably 65° C.-70° C. The batch pH at this step is maintained at 7-9, preferably 7.5-8.5. In samples comprising a thiourea-formaldehyde polymer as the sulfur compound, the thiourea-formaldehyde polymer is synthesized as follows: 53% formaldehyde (F₁) is charged into the batch, and the pH is adjusted to 7-9, preferably 7.5-8.5, using 50% NaOH as the pH adjuster (with or without sulfuric acid and/or formic acid). About 0.1 wt. % to 40 wt. % (preferably about 0.5 wt. % to 30 wt. %) of thiourea (T) is then added, and the pH is readjusted to 7.0-9.0, preferably 7.5-8.5 as needed. The batch is maintained at 50° C.-75° C., preferably 55° C.-70° C., for 10-60 minutes, preferably 20-50 minutes, and the thiourea-formaldehyde polymer is formed from the reaction between formaldehyde (F₁) and thiourea (T). The (F+F₁)/(U₁+A+T) [i.e., total formaldehyde:(urea+ammonia+thiourea)] mole ratio is from 1.0-3.5, preferably from 1.5-3.0.

In step 5, the reaction mixture is cooled to 50° C.-70° C., preferably 55° C.-65° C., and the second urea (U₂) is added to the reactor. The batch temperature is held at 40° C.-60° C., preferably 45° C.-55° C. for 5-60 minutes, preferably 15-45 minutes. The pH is adjusted to 7-9.5, preferably 7.5-9, using TEA, 6% sulfuric acid and/or 10% formic acid. The final (total F)/(total U+A), or (F+F₁)/(U₁+A+T+U₂) mole ratio was from 0.5-2.5, preferably 0.8-2.0. The process for manufacturing the biopolymer-modified ammoniated polycarbamide with sulfur compounds was completed by cooling the batch to 25° C.

A summary of the synthesis process of Example 3 (b) is provided below in Table 7 (b).

TABLE 7(b)
Synthesis of Exemplary Biopolymer-Modified Ammoniated Polycarbamides

| Compound A7 | | Compound A8 | |
|---|---|---|---|
| Stage 1, Step 1: | | Stage 1, Step 1: | |
| 1) | Charge 53% Formaldehyde. | 1) | Charge 53% Formaldehyde. |
| 2) | Adjust pH to 7.5 ± 0.5 with TEA and 50% | 2) | Adjust pH to 7.5 ± 0.5 with TEA and 50% |
| | NaOH. | | NaOH. |
| 3) | Charge aqua ammonia and urea (U1). | 3) | Charge aqua ammonia and urea (U1). |
| 4) | Heat to 99° C.-102° C. and hold for 30-45 | 4) | Heat to 99° C.-102° C. and hold for 30-45 |
| | minutes or until pH stabilizes. | | minutes or until pH stabilizes. |
| Stage 1, Step 2: | | Stage 1, Step 2: | |
| 5) | Adjust pH to 4.8 ± 0.1 with 6% sulfuric acid. | 5) | Adjust pH to 4.5 ± 0.1 with 6% sulfuric acid. |
| 6) | Cook to a target “F” (Gardner-Holdt | 6) | Cook to a target “G” (Gardner-Holdt |
| | bubble viscometer) at 95° C.-100° C. | | bubble viscometer) at 95° C.-100° C. |
| 7) | Adjust pH to 7.5-8.0 with 50% NaOH while | 7) | Adjust pH to 7.5-8.0 with 50% NaOH while |
| | cooling to 85° C.-90° C. | | cooling to 85° C.-90° C. |
| Stage 2, Step 3: | | Stage 2, Step 3: | |
| 8) | Charge water. | 8) | Charge a premix of starch and water. |
| 9) | Charge a premix of starch and water. | 9) | Cook for 30 minutes at 85° C. |
| 10) | Cook for 30 minutes at 85° C. | 10) | Cool the batch to 60° C. |
| 11) | Charge water and cool to 60° C. | Stage 3, Step 4: | |
| Stage 3, Step 4: | | 11) | Charge 53% formaldehyde and adjust pH to |
| 12) | Charge SMBS (sodium metabisulfite) and | | 7.5-8.0 with 50% NaOH. |
| | hold for 30 minutes at 70° C. at a pH of | 12) | Charge thiourea and cook for 30 minutes at |
| | 7.0-9.0. | | 60° C. at pH 8.0 ± 0.5. |
| Stage 3, Step 5: | | Stage 3, Step 5: | |
| 13) | Cool the batch to 60° C. | 13) | Cool the batch to 60° C. |
| 14) | Charge urea (U2) and hold for 10 minutes | 14) | Charge urea (U2) and hold for 10 minutes at |
| | at 45° C. | | 45° C. |
| 15) | Cool the batch to 25° C. and adjust pH to | 15) | Cool the batch to 25° C. and adjust pH to |
| | 8.0 ± 0.5 with either TEA or 10% formic | | 8.0 ± 0.5 with either TEA or 10% formic |
| | acid. | | acid. |

### Example 3(c)

A biopolymer-modified ammoniated polycarbamide is synthesized using an alternative three-stage polymer process. The three stages are composed of ammoniated polycarbamide formation in the first stage (including steps 1 and 2), sulfur compound modification in the second stage (including steps 3 and 4), and biopolymer modification in the third stage (including step 5).

The first stage includes the formation of the ammoniated polycarbamide as outlined in steps 1 and 2 of Example 3 (a).

The second stage reaction constitutes the addition of the sulfur compound to the ammoniated polycarbamide in steps 3 and 4.

In step 3, sulfur compounds are included as performance-enhancing supplements. The exemplary types of sulfur compounds include sodium metabisulfite, a thiourea-formaldehyde polymer, and combinations of thereof. The level of sulfur compound varies from 0.1 wt. % to 40 wt. %. In samples comprising sodium metabisulfite as the sulfur compound, sodium metabisulfite is added to the batch at 60° C.-65° C. Mixing is continued for 5-60 minutes, preferably 15-40 minutes, at 60° C.-75° C., preferably 65° C.-70° C. The batch pH at this step is maintained at 7-9, preferably 7.5-8.5. In Compound C2 (illustrated below), thiourea-formaldehyde polymer was also included as the sulfur compound, and the polymers were prepared as follows: 53% formaldehyde (F₁) is charged into the batch, and the pH is adjusted to 7-9, preferably 7.5-8.5, using 50% NaOH as the pH adjuster (with or without sulfuric acid and/or formic acid). About 0.1 wt. % to 40 wt. % (preferably about 0.5 wt. % to 30 wt. %) of thiourea (T) is then added, and the pH is readjusted to 7-9, preferably 7.5-8.5 as needed. The batch is maintained at 50° C.-75° C., preferably 55° C.-70° C., for 10-60 minutes, preferably 20-50 minutes, and the thiourea-formaldehyde polymer is formed from the reaction between formaldehyde (F₁) and thiourea (T). The (F+F₁)/(U₁+A+T) [i.e., total formaldehyde:(urea+ammonia+thiourea)] mole ratio is from 1.0-3.5, preferably from 1.5-3.0.

In step 4, the reaction mixture is cooled to 50° C.-70° C., preferably 55° C.-65° C., and the second urea (U₂) is added to the reactor. The batch temperature is held at 40° C.-60° C., preferably 45° C.-55° C. for 5-60 minutes, preferably 15-45 minutes. The pH is adjusted to 7-9.5, preferably 7.5-9, using TEA, 6% sulfuric acid, and/or 10% formic acid. The final (total F)/(total U+A), or (F+F₁)/(U₁+A+T+U₂) mole ratio is from 0.5-2.5, preferably 0.8-2.0.

The third stage reaction (i.e., step 5 of the overall process) constitutes the modification of the supplemented ammoniated polycarbamide with a biopolymer, e.g., starch and/or carboxymethylcellulose.

In step 5, the supplemented ammoniated polycarbamide product of step 4 is cooled to a temperature of 30° C.-50° C., preferably 35° C.-45° C., and a liquid cationic starch (30% aqueous solution) is added to the reactor. The batch temperature is held for 5-60 minutes, preferably 15-45 minutes. The starch level ranges from 0.1 wt. %-30 wt. %, preferably from 0.5 wt. %-15 wt. %. The pH is adjusted to 7-9, preferably 7.5-9. The pH adjusters included 10% formic acid, 6% sulfuric acid, and triethanolamine (TEA), as needed. In Compound A9 (illustrated below), liquid carboxymethyl cellulose (CMC, 5% aqueous solution) is added to the reactor in place of the liquid starch addition. The CMC level ranges from 0.1 wt. %-30 wt. %, preferably from 0.5 wt. %-15 wt. %. The process for manufacturing the biopolymer-modified ammoniated polycarbamide with sulfur compounds is completed by cooling the batch to 20° C.-25° C.

A summary of the synthesis process of Example 3 (c) is provided below in Table 7 (c).

TABLE 7(c)
Synthesis of Exemplary Biopolymer-Modified Ammoniated Polycarbamides

| Compound A9 | | Compound A10 | |
|---|---|---|---|
| Stage 1, Step 1: | | Stage 1, Step 1: | |
| 1) | Charge 53% Formaldehyde. | 1) | Charge 53% Formaldehyde. |
| 2) | Adjust pH to 7.5 ± 0.5 with TEA and 50% | 2) | Adjust pH to 7.5 ± 0.5 with TEA and 50% |
| | NaOH. | | NaOH. |
| 3) | Charge aqua ammonia and urea (U1). | 3) | Charge aqua ammonia and urea (U1). |
| 4) | Optionally, charge SMBS. | 4) | Optionally, charge SMBS. |
| 5) | Heat to 99° C.-102° C. and hold for 30-45 | 5) | Heat to 99° C.-102° C. and hold for 30-45 |
| | minutes or until pH stabilizes. | | minutes or until pH stabilizes. |
| Stage 1, Step 2: | | Stage 1, Step 2: | |
| 6) | Adjust pH to 3.5-5.5with 6% sulfuric acid. | 6) | Adjust pH to 3.5-5.5 with 6% sulfuric acid. |
| 7) | Cook to a target “F-H” (Gardner-Holdt | 7) | Cook to a target “F-H” (Gardner-Holdt |
| | bubble viscometer) at 95° C.-100° C. | | bubble viscometer) at 95° C.-100° C. |
| 8) | Adjust pH to 7.5-9.0 with 50% NaOH while | 8) | Adjust pH to 7.5-9.0 with 50% NaOH while |
| | cooling to 85° C.-90° C. | | cooling to 85° C.-90° C. |
| Stage 2, Step 3: | | Stage 2, Step 3: | |
| 9) | Charge water and cool the batch to 60° C. | 9) | Charge water and cool the batch to 60° C. |
| 10) | Charge SMBS. | 10) | Charge SMBS. |
| 11) | Mix for 30 minutes at 70° C. and a pH of | 11) | Mix for 30 minutes at 70° C. and pH of |
| | 7.0-9.0. | | 7.0-9.0. |
| Stage 2, Step 4: | | 12) | Charge 53% formaldehyde and adjust pH to |
| 12) | Cool the batch to 60° C. | | 7.5-8.5 with TEA, 50% NaOH and optionally |
| 13) | Charge urea and hold for 10 minutes at | | 6% sulfuric acid. |
| | 45° C. | 13) | Charge thiourea and cook for 30 minutes at |
| Stage 3, Step 5: | | | 60° C. at pH 8.0 ± 0.5. |
| 14) | Charge CMC (carboxymethylcellulose) solution | Stage 2, Step 4: | |
| | (10%) and hold for 10 minutes at 40° C. | 14) | Cool the batch to 55° C.-65° C. |
| 15) | Cool the batch to 25° C. and adjust pH to | 15) | Charge urea (U2) and hold for 10 minutes at |
| | 8.0 ± 0.5 with either TEA or 10% formic | | 45° C. |

| | |
|---|---|
| acid. | Stage 3, Step 5: |

| | |
|---|---|
| 16) | Charge a liquid starch solution (30%) and hold |
| | for 10 minutes at 40° C. |
| 17) | Cool the batch to 25° C. and adjust pH to |
| | 8.0 ± 0.5 with TEA, 6% sulfuric acid, or 10% |
| | formic acid. |

### Example 3(d)

A biopolymer-modified ammoniated polycarbamide is synthesized using a three-stage polymer process. The three stages are composed of ammoniated polycarbamide formation in the first stage (including steps 1 and 2), sulfur compound modification and supplemental depressant addition in the second stage (including steps 3 and 4), and biopolymer modification in the third stage (including step 5).

The first stage includes the formation of the ammoniated polycarbamide as outlined in steps 1 and 2 of Example 3 (a), with the exception that the batch in step 1 is held at a temperature of 90° C.-107° C., preferably 99° C.-102° C. for 90-110 minutes.

The second stage reaction constitutes the addition of the sulfur compound and supplemental depressant to the ammoniated polycarbamide in steps 3 and 4.

In step 3, a sulfur compound, such as sodium sulfite, is included as a performance-enhancing supplement. The sodium sulfite is added to the batch at 55° C.-65° C. Mixing is continued for 5-60 minutes, preferably 10-30 minutes and the pH rises to 10-13, preferably 11.5-12.5. Water and about 0.1 wt. % to 40 wt. % (preferably about 0.5 wt. % to 30 wt. %) of thioglycolic acid as a supplemental depressant was charged to the batch, causing an exotherm, bringing the temperature of the batch to 50° C.-80° C., preferably 65° C.-75° C. and decreasing the pH to 7-9, preferably 7.5-8.5. The batch is maintained at 60° C.-80° C., preferably 65° C.-75° C., for 10-60 minutes, preferably 20-50 minutes.

In step 4, the reaction mixture is cooled to 50° C.-70° C., preferably 55° C.-65° C., and a second urea (U₂) is added to the reactor. The batch temperature is held at 40° C.-60° C., preferably 45° C.-55° C. for 5-60 minutes, preferably 15-45 minutes. The pH is adjusted to 7-9.5, preferably 7.5-9, using TEA, 6% sulfuric acid, and/or 10% formic acid. The final (total F)/(total U+A), or (F+F₁)/(U₁+A+T+U₂) mole ratio is from 0.5-2.5, preferably 0.8-2.0.

The third stage reaction (i.e., step 5 of the overall process) constitutes the modification of the supplemented ammoniated polycarbamide with a starch as the biopolymer.

In step 5, the supplemented ammoniated polycarbamide product of step 4 is cooled to a temperature of 30° C.-50° C., preferably 35° C.-45° C., and a liquid cationic starch (30% aqueous solution) is added to the reactor. The batch temperature is held for 5-60 minutes, preferably 15-45 minutes. The starch level ranges from 0.1 wt. %-30 wt. %, preferably from 0.5 wt. %-15 wt. %. The pH is adjusted to 7-9, preferably 7.5-9. The pH adjusters included 10% formic acid, 6% sulfuric acid, and triethanolamine (TEA), as needed. The process for manufacturing the biopolymer-modified ammoniated polycarbamide with a sulfur compound and supplemental depressant is completed by cooling the batch to 20° C.-25° C.

A summary of the synthesis process of Example 3 (d) is provided below in Table 7 (d).

TABLE 7(d)
Synthesis of Exemplary Biopolymer-
Modified Ammoniated Polycarbamides
Compound A11
Stage 1, Step 1:

| | |
|---|---|
| 1) | Charge 53% Formaldehyde and water. |
| 2) | Adjust pH to 7.5 ± 0.5 with TEA and 50% |
| | NaOH. |
| 3) | Charge aqua ammonia and urea (U1). |
| 4) | Optionally, charge SMBS. |
| 5) | Heat to 99° C.-102° C. and hold for 90-110 |
| | minutes or until pH stabilizes. |

Stage 1, Step 2:

| | |
|---|---|
| 6) | Adjust pH to 3.5-5.5 with 6% sulfuric acid. |
| 7) | Cook for 60-80 min at 95° C.-100° C. |
| 8) | Adjust pH to 7.5-9.0 with 50% NaOH while |
| | cooling to 50° C.-55° C. |

Stage 2, Step 3:

| | |
|---|---|
| 9) | Charge sodium sulfite |
| 10) | Mix for 10 minutes at 55° C.-65° C. |
| | and pH of 11.5-12.5. |
| 11) | Charge premix of water and thioglycolic acid, |
| | and an exotherm brings the temperature to |
| | 65° C.-75° C. and a pH of 7.5 ± 0.5. |
| 12) | Mix for 25-45 mins at 65° C.-75° C. |

Stage 2, Step 4:

| | |
|---|---|
| 13) | Cool the batch to 55° C.-65° C. |
| 14) | Charge urea (U2) and hold for 10 minutes |
| | at 45° C. |

Stage 3, Step 5:

| | |
|---|---|
| 15) | Charge a liquid starch solution (30%) and |
| | hold for 10 minutes at 40° C. |
| 16) | Cool the batch to 25° C. and adjust pH |
| | to 8.0 ± 0.5 with TEA, 6% sulfuric acid, |
| | or 10% formic acid. |

The compositions of the exemplary biopolymer-modified ammoniated polycarbamide separation aids are detailed in Tables 8 (a) and 8 (b) below.

TABLE 8(a)
Composition of Exemplary Biopolymer-
Modified Ammoniated Polycarbamides

| | Com- | Com- | Com- | Com- |
|---|---|---|---|---|
| | pound | pound | pound | pound |
| Composition | A5 | A6 | A7 | A8 |
| HCHO (53%)¹ | 48.00 | 48.00 | 46.00 | 45.40 |
| TEA² | 0.10 | 0.10 | 0.10 | 0.10 |
| 50% NaOH | 0.05 | 0.05 | 0.05 | 0.05 |
| Aqua Ammonia³ | 5.00 | 5.00 | 4.50 | 3.50 |
| Urea | 17.50 | 17.50 | 17.00 | 17.00 |
| 6% sulfuric acid | 0.20 | 0.20 | 0.20 | 0.40 |
| 50% NaOH | 0.05 | 0.05 | 0.06 | 0.15 |
| water | 0.00 | 5.60 | 5.00 | 0.00 |
| Starch (powder)⁴ | 0.90 | 0.90 | 0.90 | 0.90 |
| Water | 3.00 | 3.00 | 2.70 | 2.50 |
| Water | 11.70 | 0.00 | 5.00 | 0.00 |
| SMBS⁵ | 0.00 | 0.00 | 4.00 | 0.00 |
| HCHO (53%)¹ | 0.00 | 0.00 | 0.00 | 10.00 |
| Thiourea | 0.00 | 0.00 | 0.00 | 10.00 |
| Urea | 13.50 | 19.60 | 14.49 | 10.00 |
| Total [wt. %] | 100.00 | 100.00 | 100.00 | 100.00 |

¹= 53% concentration aqueous formaldehyde,
²= Triethanolamine,
³= 28% aqueous ammonia,
⁴= cationic starch powder (premix with water before charge),
⁵= sodium metabisulfite.

TABLE 8(b)
Composition of Exemplary Biopolymer-
Modified Ammoniated Polycarbamides

| | Com- | Com- | Com- |
|---|---|---|---|
| | pound | pound | pound |
| Composition | A9 | A10 | A11 |
| HCHO (53%)¹ | 33.73 | 33.73 | 24.00 |
| TEA² | 0.10 | 0.10 | 0.10 |
| 50% NaOH | 0.05 | 0.05 | 0.04 |
| SMBS³ | 0.76 | 0.76 | 0.40 |
| Aqua Ammonia⁴ | 3.80 | 3.80 | 4.00 |
| Urea | 12.64 | 12.64 | 6.80 |
| 6% sulfuric acid | 0.37 | 0.37 | 0.30 |
| 50% NaOH | 0.10 | 0.10 | 0.05 |
| Water | 13.05 | 13.05 | 11.21 |
| SMBS³ | 4.75 | 4.75 | — |
| HCHO (53%)¹ | 7.60 | 7.60 | — |
| Sodium Sulfite | — | — | 12.10 |
| Water | — | — | 8.70 |
| Thiourea | 9.50 | 9.50 | — |
| Thioglycolic Acid | — | — | 8.7 |
| Urea | 8.55 | 8.55 | 12.6 |
| Starch (30%)⁵ | 0.00 | 5.00 | 11.00 |
| Total [wt. %] | 100.00 | 100.00 | 100.00 |

¹= 53% concentration aqueous formaldehyde,
²= Triethanolamine,
³= sodium metabisulfite,
⁴= 28% aqueous ammonia,
⁵= 30% concentration aqueous cationic starch

The biopolymer-modified ammoniated polycarbamide separation aids were thereafter examined for pH, solids, viscosity, color, and stability at both 4° C. and 20° C.-25° C. storage, as summarized in Table 9. Each of the exemplary biopolymer-modified ammoniated polycarbamide separation aids demonstrated very good storage stability at 20° C.-25° C., as well as 4° C. storage stability, without any phase separation or precipitation.

TABLE 9
Characteristics of Exemplary Ammoniated Polycarbamide Separation Aids

| | | solids | Viscosity | | 4° C. | 20° C.-25° C. |
|---|---|---|---|---|---|---|
| Polymers | pH | (%) | (cP) | color | stability | stability |
| Compound A5 | 8.2 | 50 | 173 | clear | ~3 months | ~1 month |
| Compound A6 | 7.8 | 56 | 256 | clear | ~3 months | ~1 month |
| Compound A7 | 8.4 | 53 | 187 | clear | ~3 months | ~1 month |
| Compound A8 | 8.1 | 58 | 368 | clear | ~3 months | ~2 months |
| Compound A9 | 8.7 | 57 | 45 | clear | ~3 months | ~2 months |
| Compound A10 | 8.7 | 57 | 45 | clear | ~3 months | ~2 months |
| Compound A11 | 8.5 | 54 | 10 | light brown | ~6 months | ~3 months |

### Example 4—Flotation Tests

Lab-scale flotation tests were conducted using biopolymer-modified ammoniated polycarbamides, Compounds A5-A11, as described in Example 3. The tests were conducted using a Metso D-12V flotation machine (manufactured by Metso Minerals Industries, Inc.). The minerals (Cu, Mo) from the floated concentrates as well as the tailing were measured by XRF (X-Ray Fluorescence) analyzer (manufactured by Thermo Scientific Niton XL3t GOLDD+). The Cu—Mo bulk concentrate was obtained from a copper mine in Arizona in the United States. The Cu—Mo concentrate contained typical industry levels of Cu and Mo, which are around 20% to 30% copper and 0.2% to 1.0% molybdenum. The biopolymer-modified ammoniated polycarbamides were employed with or without supplemental depressants for the flotation tests. When the biopolymer-modified ammoniated polycarbamides were employed with supplemental depressants for the flotation study, the biopolymer-modified ammoniated polycarbamides and the supplemental depressants may be added separately, or they may be pre-mixed prior to the test and added as a one-part system.

The lab-scale flotation cell test was conducted according to the following procedure: (1) thaw 500 g of ore sample (Cu—Mo concentrate) in a warm water bath; (2) transfer the Cu—Mo bulk concentrate to a flotation cell; (3) start the impeller and adjust the speed to 900 rpm; (4) control the pulp (Cu—Mo concentrate) level to be just below the target (not to overflow before the air) and mix the slurry; (5) check the pulp pH and ORP (Oxidation-Reduction Potential) prior to the addition of chemicals (control NaSH or exemplary biopolymer-modified ammoniated polycarbamides); (6) slowly add chemicals to the flotation cell (e.g., control NaSH: ˜550 mV ORP for full Cu depression); (7) add diesel as Mo collector if needed; (8) start and adjust air to the target flow rate (2 L/min or as needed); (9) float concentration 1 (first scrape of float bubbles) for 2 min in a collection pan (concentration 1) and measure the weight of the concentration 1 before the vacuum dry (mass pull 1); (10) record pH and ORP; (11) replace the collection pan and float concentration 2 for 3 min in a collection pan (concentration 2) and measure the weight of the concentration 2 before the vacuum dry (mass pull 2); and (12) record pH and ORP.

The XRF (X-Ray Fluorescence) measurement was conducted according to the following procedure: (1) vacuum-dry conc 1 (float concentration 1) and conc 2 (float concentration 2), as well as the tailing (depressed mineral), and measure the weight of each material (i.e., the total mineral concentrate is the sum of vacuum-dried concentration 1, vacuum-dried concentration 2, and vacuum-dried tailing); (2) oven-dry the materials overnight at 125° C., and measure the weight of each material; (3) measure and analyze the minerals from each material, and select Cu, Mo, Fe amounts on the XRF device; and (4) analyze Cu, Mo, Fe concentrations and obtain the recovery and grade of these minerals.

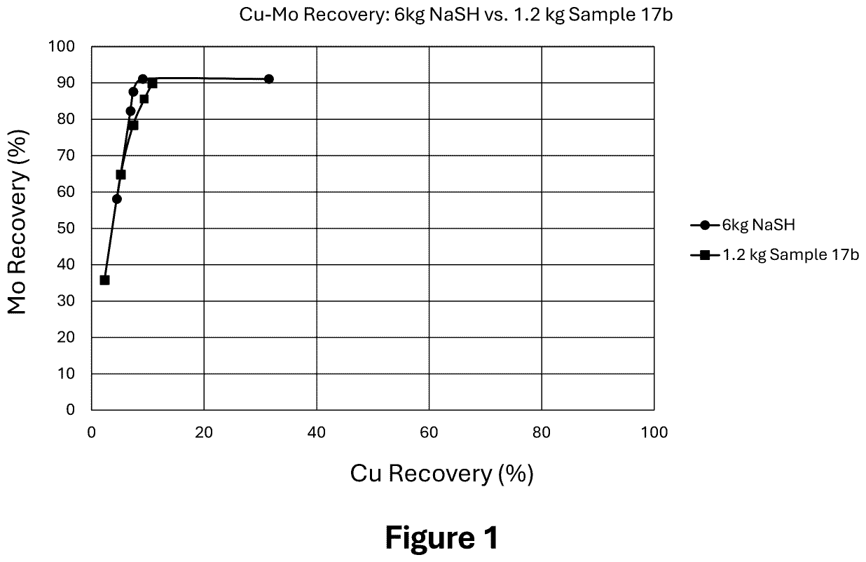

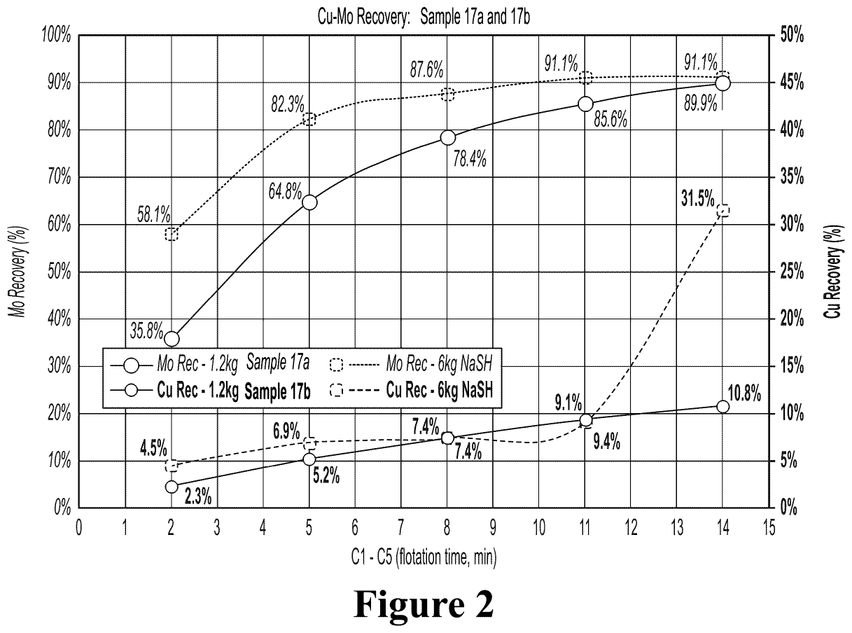

The results of the lab-scale flotation cell tests are summarized in Tables 10-14 and FIGS. 1 and 2.

TABLE 10
Flotation Cell Test Results (Study #1)

| | Study #1 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 6.0 | 6.0 | 5.0 | 85.3 | 22.8 | 6.7 |
| Sample 13 | Compound A6 | NaSH | 0.5 | 2.0 | 2.5 | 6.9 | 72.1 | 24.0 | 5.0 |

TABLE 11
Flotation Cell Test Results (Study #2)

| | Study #2 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 5.0 | 5.0 | 7.1 | 81.4 | 23.3 | 5.5 |
| Sample 14a | Compound A6 | NaSH | 0.5 | 1.5 | 2.0 | 8.1 | 67.7 | 24.2 | 4.3 |
| Sample 14b | Compound A7 | NaSH | 0.5 | 1.5 | 2.0 | 7.9 | 63.1 | 24.2 | 4.3 |
| Sample 14c | Compound A8 | NaSH | 0.5 | 1.5 | 2.0 | 8.9 | 65.4 | 24.6 | 3.9 |
| Sample 14d | Compound A5 | S-TGA | 0.5 | 1.5 | 2.0 | 6.9 | 47.3 | 24.5 | 4.0 |
| Sample 14e | Compound A7 | S-TGA | 0.5 | 1.5 | 2.0 | 5.2 | 51.3 | 23.4 | 5.0 |
| Sample 14f | Compound A8 | S-TGA | 0.5 | 1.5 | 2.0 | 7.0 | 75.9 | 23.9 | 4.9 |
| Sample 14g | — | S-TG | — | 2.0 | 2.0 | 15.7 | 72.3 | 25.8 | 2.8 |
| Sample 14h | Compound A10 | S-TGA | 0.5 | 1.5 | 2.0 | 4.9 | 53.3 | 23.4 | 5.3 |

TABLE 12
Flotation Cell Test Results (Study #3)

| | Study #3 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 6.0 | 6.0 | 4.9 | 74.6 | 23.0 | 5.9 |
| Sample 15a | Compound A9 | NaSH | 0.6 | 2.4 | 3.0 | 3.7 | 63.0 | 22.6 | 6.1 |
| Sample 15b | Compound A10 | NaSH | 0.6 | 2.4 | 3.0 | 3.6 | 58.2 | 22.5 | 6.3 |

TABLE 13
Flotation Cell Test Results (Study #4)

| | Study #4 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 6.0 | 6.0 | 6.8 | 95.8 | 23.1 | 4.1 |
| Sample 16 | Compound A6 | NaSH | 1.0 | 2.4 | 3.4 | 3.6 | 80.8 | 22.9 | 5.9 |

TABLE 14a
Flotation Cell Test Results (Study #5)

| | Study #5 | | | | | | | | | |
|---|---|---|---|---|---|---|---|---|---|---|
| | Separation | Supp. | | | | | | | | |
| | Aid | Depressant | Dosages (kg/T) | | | Recovery (%) Mo | | | | |
| Condition | I | II | I | II | Total | 2 mins | 5 mins | 8 mins | 11 mins | 14 mins |
| Control | — | NaSH | — | 6.0 | 6.0 | 58.1 | 82.3 | 87.6 | 91.1 | 91.1 |
| Sample 17a | Compound A11 | — | 1.2 | — | 1.2 | 35.8 | 64.8 | 78.4 | 85.6 | 89.9 |

TABLE 14b
Flotation Cell Test Results (Study #5)

| | Study #5 | | | | | | | | | |
|---|---|---|---|---|---|---|---|---|---|---|
| | Separation | Supp. | | | | | | | | |
| | Aid | Depressant | Dosages (kg/T) | | | Recovery (%) Cu | | | | |
| Condition | I | II | I | II | Total | 2 mins | 5 mins | 8 mins | 11 mins | 14 mins |
| Control | — | NaSH | — | 6.0 | 6.0 | 4.5 | 6.9 | 7.4 | 9.1 | 31.5 |
| Sample 17b | Compound A11 | — | 1.2 | — | 1.2 | 2.3 | 5.2 | 7.4 | 9.4 | 10.8 |

TABLE 14c
Flotation Cell Test Results (Study #5)

| | Study #5 | | | | | | | | | |
|---|---|---|---|---|---|---|---|---|---|---|
| | Separation | Supp. | | | | | | | | |
| | Aid | Depressant | Dosages (kg/T) | | | Grade (%) Mo | | | | |
| Condition | I | II | I | II | Total | 2 mins | 5 mins | 8 mins | 11 mins | 14 mins |
| Control | — | NaSH | — | 6.0 | 6.0 | 4.6 | 4.3 | 4.2 | 3.6 | 1.2 |
| Sample 17c | Compound A11 | — | 1.2 | — | 1.2 | 5.2 | 4.3 | 3.6 | 3.1 | 2.9 |

TABLE 14d
Flotation Cell Test Results (Study #5)

| | Study #5 | | | | | | | | | |
|---|---|---|---|---|---|---|---|---|---|---|
| | Separation | Supp. | | | | | | | | |
| | Aid | Depressant | Dosages (kg/T) | | | Grade (%) Cu | | | | |
| Condition | I | II | I | II | Total | 2 mins | 5 mins | 8 mins | 11 mins | 14 mins |
| Control | — | NaSH | — | 6.0 | 6.0 | 23.4 | 23.5 | 23.6 | 23.9 | 26.2 |
| Sample 17d | Compound A11 | — | 1.2 | — | 1.2 | 23.3 | 23.7 | 24.1 | 24.5 | 24.6 |

Overall, as detailed in Tables 10-14, the biopolymer-modified ammoniated polycarbamide compositions described herein, with and without supplemental depressants, provided similar recovery of Cu and Mo as the control NaSH, and reduced or replaced NaSH at much lower chemical treatment levels. For example, the biopolymer-modified polycarbamide composition (Sample 14d, Compound A5 with S-TGA), the biopolymer-modified polycarbamide composition with sulfur compounds (Sample 14e, Compound A7 with S-TGA; Sample 14f, Compound A8 with S-TGA), and the biopolymer-modified polycarbamide composition with sulfur compounds (Sample 14h, Compound A10 with S-TGA) demonstrated better Cu depression (lower Cu recovery value) and similar Mo recovery (good Cu—Mo separation) than the control NaSH at 60% total reduced chemical treatment level (than the control NaSH) and was able to replace 100% NaSH.

Moreover, as illustrated in Tables 14a and 14b, along with FIGS. 1 and 2, the biopolymer-modified ammoniated polycarbamide with a sulfur compound and a supplemental depressant (Sample 17, Compound A11) demonstrated very similar Mo recovery to NaSH, particularly as the flotation time increased to 8 minutes, 11 minutes, and 14 minutes. However, this data clearly illustrates that NaSH will oxidize after 11 minutes and begins to lose effectiveness in depressing Cu, while Sample 17 continues to suppress Cu effectively.

Further, as illustrated in Tables 14c and 14d, each of the Control samples and Sample A11 resulted in similar Mo and Cu grades. However, in the Control samples, the Mo grade suddenly drops at 14 min (Mo drops to 1.2%), which indicates NaSH oxidation (more Cu floated, which lowers the Mo purity). Similarly, the Cu grade at 14 min suddenly increases to 26.2% due to more floated Cu caused by NaSH oxidation.

### Example 5—Preparation of a Hydrophilic Polymer-Modified Polycarbamide Separation Aid

### Example 5(a)

Exemplary separation aids are prepared by synthesizing hydrophilic polymer-modified, sulfur containing ammoniated polycarbamide using a two-stage polymer process. The first stage forms the hydrophilic polymer-modified ammoniated polycarbamide (steps 1 and 2), and the second stage modifies the hydrophilic polymer-modified ammoniated polycarbamide with a performance enhancing supplement (including steps 3 and 4).

In step 1, formaldehyde is charged into a reactor and the pH is adjusted to 7-9, preferably 7.5-8.5. Aqueous formaldehyde (53% concentration) is used for the polymer synthesis. Alternatively, urea-formaldehyde concentrate (UFC) may be used for the polymer synthesis. An exemplary UFC is composed of 60 wt. % formaldehyde, 25 wt. % urea, and 15 wt. % water. The pH adjusters include triethanolamine (TEA) and 50% NaOH, as well as 6% sulfuric acid, or 10% formic acid, as needed. A solution of 30% aqueous ammonia is then added to the mixture, along with 0.1 wt. % to 20 wt. %, preferably 0.5 wt. % to 10 wt. %, of N-methylolacrylamide (nMA). Optionally, a small quantity of sodium metabisulfite (SMBS) is charged to the batch to improve the stability and solubility of the polymer, as needed. Thereafter, a first urea charge (U₁) is added to the reactor, and the temperature is increased to 90° C.-107° C., preferably 95° C.-102° C. The batch is held at this temperature for 30-60 minutes, preferably for 40-50 minutes. The F/U₁ [i.e., formaldehyde:urea] mole ratio is from 1.5-4.0, preferably from 2.0-3.5. The F/(U₁+A) [i.e., formaldehyde:(urea+ammonia) mole ratio is from 1.0-4.0, preferably from 1.5-3.5. The urea and formaldehyde are reacted near neutral, at a pH range of 7.0-9.0, preferably 7.5-8.5, to form various hydroxymethylureas (i.e., UF methylolation). The ammonia and formaldehyde are reacted near neutral, at a pH range of 7-9, preferably 7.5-8.5, to form various hydroxymethylammonias (i.e., AF methylolation). Thereafter, the methylol ammonia and urea are reacted near neutral pH to form triazones and its derivatives (i.e., UFA ammoniation).

In step 2, the temperature is decreased to 50° C.-85° C., preferably 60° C.-75° C., and the pH is decreased to an acidic range of 3-6, preferably 3.5-5.5. Ammonium persulfate (APS) is slowly charged to the batch as an initiator for a radical polymerization of nMA. The level of initiator, on a solids basis, was 0.001 wt. %-2 wt. %, preferably 0.01 wt. %-0.5 wt. % in the 100% liquid batch solution. The temperature was adjusted to 70° C.-90° C., preferably 75° C.-85° C. After the completion of the APS charge, the pH is decreased to an acidic range of 3.5-6.0, preferably 4.0-5.5. The pH adjusters include 6% sulfuric acid, 10% formic acid, and/or triethanolamine (TEA) as needed. The hydrophilic polymer (nMA) begins to form during this step, and the viscosity of the batch increases over time. The second step is ended at a target Gardner-Holdt (G-H) bubble viscosity of “D-UV” (preferably, “K-P”) at 80° C. The pH is increased to 7-9, preferably 7.5-8.5, using TEA and 50% NaOH as the pH adjusters. The hydrophilic polymer (N-methylolacrylamide polymer) is mainly formed via radical polymerization during this step and some minor amounts of polycarbamide is also formed in this step under acidic conditions. After reaching the target viscosity, vacuum cooling or cooling water is applied to lower the temperature of the batch to 50° C.-75° C., preferably 55° C.-70° C. A water charge is employed in this step to adjust the solids content and the viscosity of the batch.

The second stage includes the addition of a performance enhancing supplement to the hydrophilic polymer-modified ammoniated polycarbamide in steps 3 and 4.

In step 3, thiourea (T), as a performance enhancing supplement, is added to the batch for improved Cu depression (or potentially other minerals as well), at 50° C.-75° C. (preferably at 55° C.-70° C.). The batch is held for 10-60 minutes (preferably for 20-40 minutes) at 50° C.-75° C. (preferably at 55° C.-70° C.). The batch pH was adjusted to 7-9 (preferably to 7.5-8.5) using TEA (triethanolamine) and 50% NaOH with or without 6% sulfuric acid and/or 10% formic acid. During this step, thiourea is reacted with formaldehyde, which is presented without reacting with urea from the previous steps and forms a thiourea-formaldehyde polymer. Different types of thiourea derivatives beside thiourea may be used, such as, for example, cyclohexyl thiourea, phenylthiourea, N-allylthiourea, etc. The level of thiourea can be varied in the range from about 0.1 wt. %-40 wt. % (preferably from 0.5 wt. %-30 wt. %). These performance enhancing supplements improved the stability of the hydrophilic polymer-modified polycarbamide as well as Cu depression (or potentially other minerals). See Tables 15, 16, 17, and 18. The mole ratio of F/(U₁+A+T) can range from about 1-3.5 (preferably varying from about 1.5-3).

In step 4, the reaction mixture is cooled to 50° C.-70° C., preferably 55° C.-65° C., and the second urea (U₂) is added to the reactor. The batch temperature is held at 40° C.-60° C., preferably 45° C.-55° C. for 5-60 minutes, preferably 15-45 minutes. The pH is adjusted to 7-9.5, preferably 7.5-9.0, using TEA and 6% sulfuric acid and/or 10% formic acid. The final (total F)/(total U+A), or F/(U₁+A+U₂) mole ratio was from 0.5-2.5, preferably 0.8-2.0. The process for manufacturing the hydrophilic polymer-modified ammoniated polycarbamide was completed by cooling the batch to 20° C.-25° C.

A summary of the synthesis process of Example 5 (a) is provided below in Table 15 (a).

TABLE 15(a)
Synthesis of Exemplary Hydrophilic
Polymer-Modified Ammoniated Polycarbamides
Compound A12
Stage 1, Step 1:

| | |
|---|---|
| 1) | Charge 53% Formaldehyde. |
| 2) | Adjust pH to 7.5 ± 0.5 with TEA and 50% |
| | NaOH. |
| 3) | Charge aqua ammonia. |
| 4) | Charge nMA (N-methylacrylamide). |
| 5) | Charge urea. |
| 6) | Heat to 99° C.-102° C. and hold for 30-45 |
| | minutes or until pH stabilizes. |

Stage 1, Step 2:

| | |
|---|---|
| 7) | Cool the batch to 60° C. |
| 8) | Slowly charge APS (ammonium persulfate) |
| | and adjust pH to 4.5-5.0 with either TEA |
| | or 10% formic acid after the pH stabilizes. |
| 9) | Cook to a target “D” (Gardner-Holdt |
| | bubble viscometer) at 80° C. |
| 10) | Adjust pH to 7.5-8.0 with 50% NaOH and |
| | cool water to 55° C.-70° C. |
| 11) | Charge water |

Stage 2, Step 3:

| | |
|---|---|
| 12) | Charge thiourea at 50° C.-75° C. |
| 13) | Cook for 30 minutes at 60° C. at pH 8.0 ± 0.5. |

Stage 2, Step 4:

| | |
|---|---|
| 14) | Charge urea and hold for 10-15 minutes at |
| | 50° C.-75 C. ° C. |
| 15) | Cool the batch to 25° C. and adjust pH to 8.0 ± |
| | 0.5 with either TEA or 10% formic acid. |

### Example 5(b)

A hydrophilic polymer-modified ammoniated polycarbamide with performance enhancing supplements and biopolymer additive is synthesized using a three-stage polymer process. The first stage forms the hydrophilic polymer-modified ammoniated polycarbamide (including steps 1 and 2), the second stage modifies the hydrophilic polymer-modified ammoniated polycarbamide with a performance enhancing supplement (including step 3), and the third stage introduces a biopolymer compound (including step 4).

The first stage includes the formation of the hydrophilic polymer-modified ammoniated polycarbamide as outlined in steps 1 and 2 of Example 5 (a). The second stage constitutes the modification of the ammoniated polycarbamide with a performance enhancing supplement, as outlined in steps 3 of Example 5 (a).

The second stage further includes the addition of one or more biopolymers in step 4. In step 4, the reaction mixture is cooled to 50° C.-70° C., preferably 55° C.-65° C., and a second urea (U₂) is added to the reactor. The batch temperature is held at 40° C.-60° C., preferably 45° C.-55° C. for 5-60 minutes, preferably 15-45 minutes. The pH is adjusted to 7-9.5, preferably 7.5-9, using TEA, 6% sulfuric acid and/or 10% formic acid. The final (total F)/(total U+A), or (F+F₁)/(U₁+A+T+U₂) mole ratio was from 0.5-2.5, preferably 0.8-2.0. A liquid cationic starch biopolymer (30% aqueous solution) in an amount from 0.1%-30% (preferably from around 0.5%-10%) is added and the batch temperature is held at 30° C.-50° C. (preferably at 35° C.-45° C.) for 5-60 minutes (preferably for 15-45 minutes). The hydrophilic polymer-modified polycarbamide with performance enhancing supplements with biopolymer manufacturing process is completed by cooling the batch to 22° C.-26° C.

A summary of the synthesis process of Example 5 (b) is provided below in Table 15 (b).

TABLE 15(b)
Synthesis of Exemplary Hydrophilic Polymer-
Modified Ammoniated Polycarbamides with Biopolymer
Compound A13
Stage 1, Step 1:

| | |
|---|---|
| 1) | Charge 53% Formaldehyde. |
| 2) | Adjust pH to 7.0-9.0 with TEA and 50% |
| | NaOH. |
| 3) | Charge aqua ammonia. |
| 4) | Charge nMA (N-methylacrylamide). |
| 5) | Charge urea. |
| 6) | Heat to 99° C.-102° C. and hold for 30-45 |
| | minutes or until pH stabilizes. |

Stage 1, Step 2:

| | |
|---|---|
| 7) | Cool the batch to 60° C. |
| 8) | Slowly charge APS (ammonium persulfate) |
| | and adjust pH to 4.5-5.0 with either TEA |
| | or 10% formic acid after the pH stabilizes. |
| 9) | Cook to a target “D” (Gardner-Holdt |
| | bubble viscometer) at 80° C. |
| 10) | Adjust pH to 7.5-8.0 with 50% NaOH and |
| | cool water to 55° C.-70° C. |
| 11) | Charge water |

Stage 2, Step 3:

| | |
|---|---|
| 12) | Charge thiourea at 50° C.-75° C. |
| 13) | Cook for 30 minutes at 60° C. at pH 8.0 ± |
| | 0.5. |

Stage 2, Step 4:

| | |
|---|---|
| 14) | Cool the batch to 50° C.-70° C. |
| 15) | Charge urea and hold for 10 minutes at |
| | 40° C.-60° C. |
| 16) | Adjust pH to 7.0-9.5 with TEA and 6% |
| | sulfuric acid. |
| 17) | Charge a liquid starch solution (30%) and |
| | hold for 5-60 minutes at 40° C. |
| 18) | Cool the batch to 25° C. and adjust pH to 8.0 ± |
| | 0.5 with either TEA or 10% formic acid. |

### Example 5(c)

Exemplary separation aids are prepared by synthesizing hydrophilic polymer-modified, sulfur containing ammoniated polycarbamide using a two-stage polymer process. The first stage forms the hydrophilic polymer-modified ammoniated polycarbamide (steps 1 and 2), and the second stage modifies the hydrophilic polymer-modified ammoniated polycarbamide with a performance enhancing supplement and introduces a supplemental depressant (including steps 3 and 4).

The first stage includes the formation of the hydrophilic polymer-modified ammoniated polycarbamide as outlined in step 1 of Example 5 (a).

In step 2, the temperature is decreased to 50° C.-85° C., preferably 60° C.-75° C., and the pH is decreased to an acidic range of 3-6, preferably 3.5-5.5, with a pH adjuster, such as TEA or 10% formic acid. Ammonium persulfate (APS) is slowly charged to the batch as an initiator for a radical polymerization of nMA. The level of initiator, on a solids basis, was 0.001 wt. %-2 wt. %, preferably 0.01 wt. %-0.5 wt. % in the 100% liquid batch solution. The temperature was adjusted to 75° C.-85° C. and the mixture is cooked for 90-110 minutes. The pH is then increased to 7.5-8.0 with a basic pH adjuster, such as NaOH.

The second stage includes the addition of a performance enhancing supplement and supplemental depressant to the hydrophilic polymer-modified ammoniated polycarbamide in steps 3 and 4.

In step 3, sodium sulfite, as a performance enhancing supplement, is added to the batch at 50° C.-75° C. (preferably at 55° C.-65° C.). The batch is held for 10 minutes at a pH of 11.5-12.5. A premix of water and thioglycolic acid is then charged and an exotherm bring the temperature of the mixture to 65° C.-75° C. and the pH to 7.5+/−0.5. The reaction mixture is blended for 25-45 minutes at 65° C.-75° C.

In step 4, the reaction mixture is cooled to 50° C.-75° C., and the second urea (U₂) is added to the reactor. The batch temperature is held at 50° C.-75° C. for 10-15 minutes. The pH is adjusted to 7-8.5 using TEA and 6% sulfuric acid and/or 10% formic acid. The process for manufacturing the hydrophilic polymer-modified ammoniated polycarbamide was completed by cooling the batch to 20° C.-25° C.

A summary of the synthesis process of Example 5 (c) is provided below in Table 15 (c).

TABLE 15(c)
Synthesis of Exemplary Hydrophilic Polymer-
Modified Ammoniated Polycarbamides
Compound A14
Stage 1, Step 1:

| | |
|---|---|
| 1) | Charge 53% Formaldehyde. |
| 2) | Adjust pH to 7.5 ± 0.5 with TEA and 50% |
| | NaOH. |
| 3) | Charge aqua ammonia. |
| 4) | Charge nMA (N-methylacrylamide). |
| 5) | Charge urea. |
| 6) | Heat to 99° C.-102° C. and hold for 60-80 |
| | minutes or until pH stabilizes. |

Stage 1, Step 2:

| | |
|---|---|
| 7) | Cool the batch to 60° C. |
| 8) | Slowly charge APS (ammonium persulfate) |
| | and adjust pH to 4.5-5.0 with either TEA |
| | or 10% formic acid after the pH stabilizes. |
| 9) | Cook for 90-110 minutes at 75° C.-85° C. |
| | 10) Adjust pH to 7.5-8.0 with 50% NaOH |
| | while cooling to 50° C.-55° C. |

Stage 2, Step 3:

| | |
|---|---|
| 11) | Charge sodium sulfite |
| 12) | Mix for 10 minutes at 55° C.-65° C. and |
| | pH of 11.5-12.5. |
| 13) | Charge premix of water and thioglycolic acid, |
| | and an exotherm brings the temperature to |
| | 65° C.-75° C. and a pH of 7.5 ± 0.5. |
| 14) | Mix for 25-45 mins at 65° C.-75° C. |

Stage 2, Step 4:

| | |
|---|---|
| 15) | Charge urea and hold for 10-15 minutes at |
| | 50° C.-75 C. ° C. |
| 16) | Cool the batch to 25° C. and adjust pH to |
| | 8.0 ± 0.5 with either TEA or 10% formic acid. |

### Example 5(d)

Exemplary separation aids are prepared by synthesizing hydrophilic polymer-modified, sulfur containing ammoniated polycarbamide using a two-stage polymer process. The first stage forms the hydrophilic polymer-modified ammoniated polycarbamide (steps 1 and 2), and the second stage modifies the hydrophilic polymer-modified ammoniated polycarbamide with a performance enhancing supplement and introduces a supplemental depressant (including steps 3 and 4).

The first stage includes the formation of the hydrophilic polymer-modified ammoniated polycarbamide as outlined in steps 1 and 2 of Example 5 (c). The second stage constitutes the modification of the ammoniated polycarbamide with a performance enhancing supplement, as outlined in step 3 of Example 5 (c).

In step 4, the reaction mixture is cooled to 50° C.-75° C., and the second urea (U₂) is added to the reactor. The batch temperature is held at 50° C.-75° C. for 10-15 minutes. The mixture is then cooled to 20° C.-25° C. and S-TGA is added to the reactor. The mixture is charged blended for 20-30 minutes and the pH is adjusted to 7.3-8.7 using TEA and 6% sulfuric acid and/or 10% formic acid.

A summary of the synthesis process of Example 5 (d) is provided below in Table 15 (d).

TABLE 15(d)
Synthesis of Exemplary Hydrophilic Polymer-
Modified Ammoniated Polycarbamides
Compound A15
Stage 1, Step 1:

| | |
|---|---|
| 1) | Charge 53% Formaldehyde. |
| 2) | Adjust pH to 7.5 ± 0.5 with TEA and 50% |
| | NaOH. |
| 3) | Charge aqua ammonia. |
| 4) | Charge nMA (N-methylacrylamide). |
| 5) | Charge urea. |
| 6) | Heat to 99° C.-102° C. and hold for 60-80 |
| | minutes or until pH stabilizes. |

Stage 1, Step 2:

| | |
|---|---|
| 7) | Cool the batch to 60° C. |
| 8) | Slowly charge APS (ammonium persulfate) |
| | and adjust pH to 4.5-5.0 with either TEA |
| | or 10% formic acid after the pH stabilizes. |
| 9) | Cook for 90-110 minutes at 75° C.-85° C. |
| 10) | Adjust pH to 7.5-8.0 with 50% NaOH while |
| | cooling to 50° C.-55° C. |

Stage 2, Step 3:

| | |
|---|---|
| 11) | Charge sodium sulfite |
| 12) | Mix for 10 minutes at 55° C.-65° C. and |
| | pH of 11.5-12.5. |
| 13) | Charge premix of water and thioglycolic |
| | acid, and an exotherm brings the temperature |
| | to 65° C.-75° C. and a pH of 7.5 + 0.5. |
| 14) | Mix for 25-45 mins at 65° C.-75° C. |

Stage 2, Step 4:

| | |
|---|---|
| 15) | Charge urea and hold for 10-15 minutes at |
| | 50° C.-75 C. ° C. |
| 16) | Cool the batch to 25° C.17) Charge S-TGA |
| | and mix for 20-30 min and adjust pH to 8.0 ± |
| | 0.7 with either TEA or 10% formic acid. |

### Example 5(e)

Exemplary separation aids are prepared by synthesizing hydrophilic polymer-modified, sulfur containing ammoniated polycarbamide using a two-stage polymer process. The first stage forms the hydrophilic polymer-modified ammoniated polycarbamide (steps 1 and 2), and the second stage modifies the hydrophilic polymer-modified ammoniated polycarbamide with a performance enhancing supplement and introduces a supplemental depressant (including steps 3 and 4).

The first stage includes the formation of the hydrophilic polymer-modified ammoniated polycarbamide as outlined in steps 1 and 2 of Example 5 (c). The second stage constitutes the modification of the ammoniated polycarbamide with a performance enhancing supplement, as outlined in step 3 of Example 5 (c).

In step 4, the reaction mixture is cooled to 50° C.-75° C., and the second urea (U₂) is added to the reactor. The batch temperature is held at 50° C.-75° C. for 10-15 minutes. The mixture is then cooled to 20° C.-25° C. and PEO (polyethylene oxide) is added to the reactor. The mixture is charged blended for 20-30 minutes and then S-TGA is added to the reactor and pH is adjusted to 7.3-8.7 using TEA and 6% sulfuric acid and/or 10% formic acid.

A summary of the synthesis process of Example 5 (e) is provided below in Table 15 (e).

TABLE 15(e)
Synthesis of Exemplary Hydrophilic Polymer-
Modified Ammoniated Polycarbamides
Compound A16
Stage 1, Step 1:

| | |
|---|---|
| 1) | Charge 53% Formaldehyde. |
| 2) | Adjust pH to 7.5 ± 0.5 with TEA and 50% |
| | NaOH. |
| 3) | Charge aqua ammonia. |
| 4) | Charge nMA (N-methylacrylamide). |
| 5) | Charge urea. |
| 6) | Heat to 99° C.-102° C. and hold for 60-80 |
| | minutes or until pH stabilizes. |

Stage 1, Step 2:

| | |
|---|---|
| 7) | Cool the batch to 60° C. |
| 8) | Slowly charge APS (ammonium persulfate) |
| | and adjust pH to 4.5-5.0 with either TEA |
| | or 10% formic acid after the pH stabilizes. |
| 9) | Cook for 90-110 minutes at 75° C.-85° C. |
| 10) | Adjust pH to 7.5-8.0 with 50% NaOH while |
| | cooling to 50° C.-55° C. |

Stage 2, Step 3:

| | |
|---|---|
| 11) | Charge sodium sulfite |
| 12) | Mix for 10 minutes at 55° C.-65° C. and |
| | pH of 11.5-12.5. |
| 13) | Charge premix of water and thioglycolic |
| | acid, and an exotherm brings the temperature |
| | to 65° C.-75° C. and a pH of 7.5 + 0.5. |
| 14) | Mix for 25-45 mins at 65° C.-75° C. |

Stage 2, Step 4:

| | |
|---|---|
| 15) | Charge urea and hold for 10-15 minutes at |
| | 50° C.-75 C. ° C. |
| 16) | Cool the batch to 25° C. |
| 17) | Charge PEO and mix for 20-30 min. |
| 18) | Charge S-TGA and mix for 20-30 min and |
| | adjust pH to 8.0 ± 0.7 with either TEA |
| | or 10% formic acid. |

The compositions of the exemplary hydrophilic polymer-modified ammoniated polycarbamide separation aids are detailed in Table 15 (f) below.

TABLE 15(f)
Composition of Exemplary Hydrophilic Polymer-
Modified Ammoniated Polycarbamides

| | Com- | Com- | Com- | Com- | Com- |
|---|---|---|---|---|---|
| | pound | pound | pound | pound | pound |
| Composition | A12 | A13 | A14 | A15 | A16 |
| HCHO (53%)¹ | 48.00 | 46.56 | 28.74 | 7.18 | 11.25 |
| water | — | — | 7.59 | 1.90 | 4.27 |
| TEA² | 0.10 | 0.10 | 0.09 | 0.02 | 0.04 |
| 50% NaOH | 0.03 | 0.03 | 0.03 | 0.01 | 0.01 |
| SMBS⁷ | — | — | 0.46 | 0.11 | 0.18 |
| Aqua Ammonia³ | 4.00 | 3.88 | 3.45 | 0.86 | 1.58 |
| nMA⁴ | 3.50 | 3.40 | 2.30 | 0.57 | 1.13 |
| Urea | 16.50 | 16.00 | 8.62 | 2.16 | 3.38 |
| APS⁵ | 0.05 | 0.05 | 0.05 | 0.01 | 0.03 |
| 6% sulfuric acid | 0.00 | 0.00 | — | — | — |
| Sodium sulfite | — | — | 13.91 | 3.48 | 8.28 |
| 50% NaOH | 0.10 | 0.10 | 0.06 | 0.01 | 0.02 |
| Water | 10.00 | 9.70 | 9.89 | 2.47 | 4.50 |
| Thiourea | 5.00 | 4.85 | — | — | — |
| Thioglycolic acid | — | — | 14.94 | 3.74 | 4.5 |
| Urea | 12.72 | 12.33 | 14.94 | 3.74 | 4.50 |
| Starch (30%)⁶ | 0.00 | 3.00 | | | |
| PEO⁸ | — | — | — | — | 5.0 |
| S-TGA⁹ | — | — | — | 75.0 | 50.0 |
| Total | 100 | 100 | 100 | 100 | 100 |

¹= 53% concentration aqueous formaldehyde,
²= Triethanolamine,
³= 28% aqueous ammonia,
⁴N-methylacrylamide,
⁵= ammonium persulfate,
⁶= 30% concentration aqueous cationic starch,
⁷= sodium metabisulfite,
⁸= poly(ethyleneoxide),
⁹= sodium thioglycolate.

The finished exemplary hydrophilic polymer-modified ammoniated polycarbamide flotation aids prepared in accordance with the present example were thereafter examined for pH, solids, viscosity, color, and stability at both 4° C. and room temperature storage, as summarized in Table 15 (g). Each of the exemplary hydrophilic polymer-modified ammoniated polycarbamide flotation aids demonstrated very good room temperature storage stability, as well as 4° C. storage stability, without any phase separation or precipitation.

TABLE 15(g)
Characteristics of Exemplary Ammoniated Polycarbamide Flotation Aids

| Polymers | pH | solids (%) | Viscosity (cP) | color | 4° C. stability | RT stability |
|---|---|---|---|---|---|---|
| Compound A12 | 8.1 | 51 | 552 | clear | ~3 months | ~1 month |
| Compound A13 | 8.1 | 50 | 580 | clear | ~3 months | ~1 month |
| Compound A14 | 8.3 | 59 | 15 | Light pink | ~6 months | ~2 months |
| Compound A15 | 8.3 | 55 | 10 | Light pink | ~6 months | ~2 months |
| Compound A16 | 8.4 | 56 | 10 | Light pink | ~6 months | ~2 months |

RT = room temperature

### Example 6—Flotation Tests

Lab-scale flotation tests were conducted using hydrophilic polymer-modified ammoniated polycarbamides, Compounds A12-A16, as described in Examples 5(a)-5(e). The tests were conducted using a Metso D-12V flotation machine (manufactured by Metso Minerals Industries, Inc.). The minerals (Cu, Mo) from the floated concentrates as well as the tailing were measured by XRF (X-Ray Fluorescence) analyzer (manufactured by Thermo Scientific Niton XL3t GOLDD+). The Cu—Mo bulk concentrate was obtained from a copper mine in Arizona in the United States. The Cu—Mo concentrate contained typical industry levels of Cu and Mo, which are around 20% to 30% copper and 0.2% to 1.0% molybdenum. The hydrophilic polymer-modified ammoniated polycarbamides were employed with or without supplemental depressants for the flotation tests. When the hydrophilic polymer-modified ammoniated polycarbamides were employed with supplemental depressants for the flotation study, the hydrophilic polymer-modified ammoniated polycarbamides and the supplemental depressants may be added separately, or they may be pre-mixed prior to the test and added as a one-part system.

The lab-scale flotation cell test was conducted according to the following procedure: (1) thaw 500 g of ore sample (Cu—Mo concentrate) in a warm water bath; (2) transfer the Cu—Mo bulk concentrate to a flotation cell; (3) start the impeller and adjust the speed to 900 rpm; (4) control the pulp (Cu—Mo concentrate) level to be just below the target (not to overflow before the air) and mix the slurry; (5) check the pulp pH and ORP (Oxidation-Reduction Potential) prior to the addition of chemicals (control NaSH or exemplary hydrophilic polymer-modified ammoniated polycarbamides); (6) slowly add chemicals to the flotation cell (e.g., control NaSH: ˜550 mV ORP for full Cu depression); (7) add diesel as Mo collector if needed; (8) start and adjust air to the target flow rate (2 L/min or as needed); (9) float concentration 1 (first scrape of float bubbles) for 2 min in a collection pan (concentration 1) and measure the weight of the concentration 1 before the vacuum dry (mass pull 1); (10) record pH and ORP; (11) replace the collection pan and float concentration 2 for 3 min in a collection pan (concentration 2) and measure the weight of the concentration 2 before the vacuum dry (mass pull 2); and (12) record pH and ORP.

The XRF (X-Ray Fluorescence) measurement was conducted according to the following procedure: (1) vacuum-dry concentration 1 (float concentration 1) and concentration 2 (float concentration 2), as well as the tailing (depressed mineral), and measure the weight of each material (i.e., the total mineral concentrate is the sum of vacuum-dried concentration 1, vacuum-dried concentration 2, and vacuum-dried tailing); (2) oven-dry the materials overnight at 125° C., and measure the weight of each material; (3) measure and analyze the minerals from each material, and select Cu, Mo, Fe amounts on the XRF device; and (4) analyze Cu, Mo, Fe concentrations and obtain the recovery and grade of these minerals.

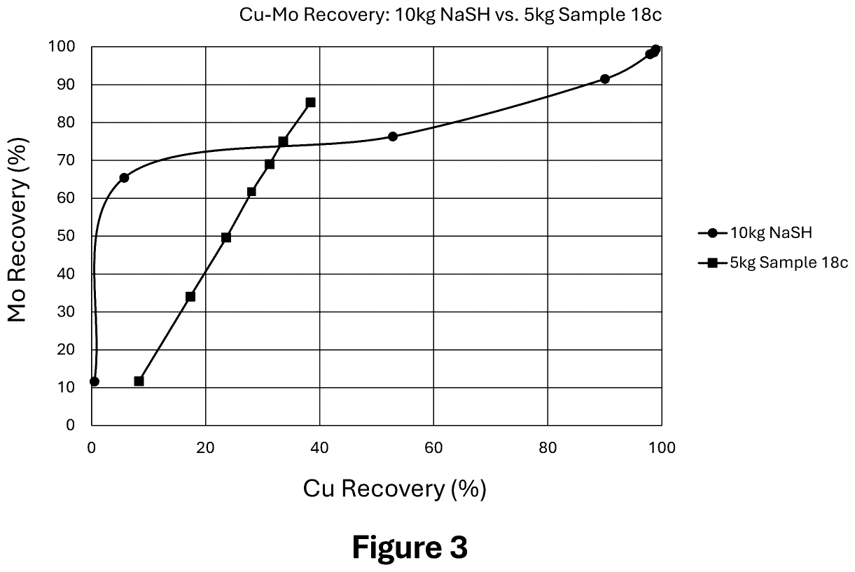

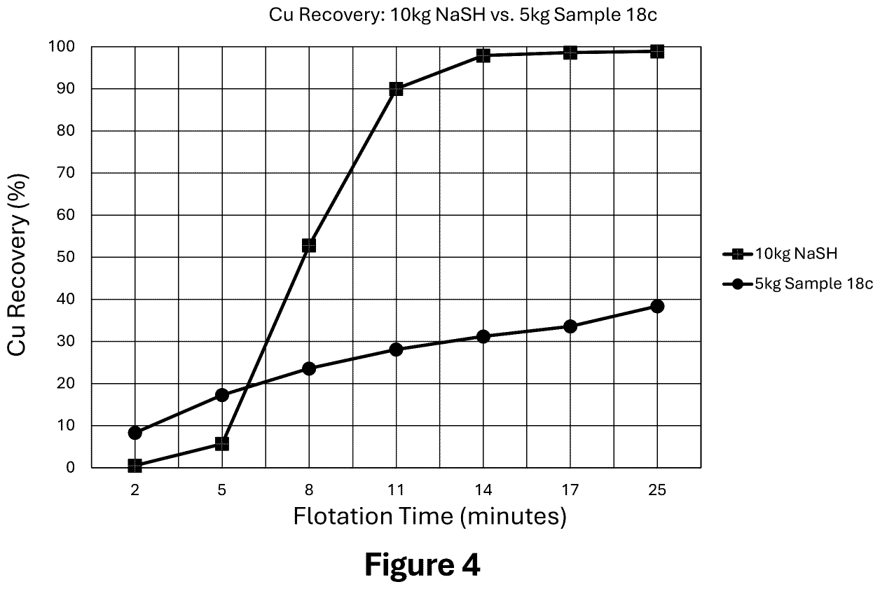

The results of the lab-scale flotation cell tests are summarized in Tables 16(a)-16(e) and FIGS. 3 and 4.

TABLE 16(a)
Flotation Cell Test Results (Study #1)

| | Study #1 | | | | | | | | |
|---|---|---|---|---|---|---|---|---|---|
| | Separation | Supp. | | | | | | | |
| | Aid | Depressant | Dosages (kg/T) | | | Recovery (%) | | Grade (%) | |
| Condition | I | II | I | II | Total | Cu | Mo | Cu | Mo |
| Control | — | NaSH | — | 6.0 | 6.0 | 6.8 | 95.8 | 23.1 | 4.1 |
| Sample 18a | Compound A12 | NaSH | 1.0 | 2.4 | 3.4 | 8.9 | 84.7 | 24.8 | 3.0 |
| Sample 18b | Compound A13 | NaSH | 1.0 | 2.4 | 3.4 | 7.6 | 77.9 | 24.5 | 3.4 |

TABLE 16(b)
Flotation Cell Test Results (Study #2)

| | Study #2 | | | | | | | | | | | |
|---|---|---|---|---|---|---|---|---|---|---|---|---|
| | Separation | Supp. | | | | | | | | | | |
| | Aid | Depressant | Dosages (kg/T) | | | Recovery (%) Cu | | | | | | |
| Condition | I | II | I | II | Total | 2 mins | 5 mins | 8 mins | 11 mins | 14 mins | 17 mins | 25 mins |
| Control | — | NaSH | — | 10.0 | 10.0 | 0.5 | 5.7 | 52.8 | 90.0 | 97.9 | 98.6 | 98.9 |
| Sample 18c | Compound A14 | S-TGA | 2.0 | 3.0 | 5.0 | 8.3 | 17.3 | 23.6 | 28.1 | 31.2 | 33.6 | 38.4 |
| Sample 18d | Compound A15 | — | 5.0 | — | 5.0 | 8.4 | 18.1 | 22.6 | 24.5 | 26.2 | 27.3 | 30.5 |
| Sample 18e | Compound A16 | — | 5.0 | — | 5.0 | 0.1 | 0.2 | 0.3 | 0.3 | 0.3 | 0.3 | |

TABLE 16(c)
Flotation Cell Test Results (Study #3)

| | Study #3 | | | | | | | | | | | |
|---|---|---|---|---|---|---|---|---|---|---|---|---|
| | Separation | Supp. | | | | | | | | | | |
| | Aid | Depressant | Dosages (kg/T) | | | Recovery (%) Mo | | | | | | |
| Condition | A | B | A | B | Total | 2 mins | 5 mins | 8 mins | 11 mins | 14 mins | 17 mins | 25 mins |
| Control | — | NaSH | — | 10.0 | 10.0 | 11.6 | 65.4 | 76.3 | 91.5 | 98.0 | 98.5 | 99.3 |
| Sample 18c | Compound A14 | S-TGA | 2.0 | 3.0 | 5.0 | 11.7 | 34.0 | 49.6 | 61.7 | 69.0 | 75.0 | 85.3 |
| Sample 18d | Compound A15 | — | 5.0 | — | 5.0 | 39.4 | 63.3 | 77.8 | 83.5 | 87.9 | 90.1 | 93.4 |
| Sample 18e | Compound A16 | — | 5.0 | — | 5.0 | 28.5 | 54.9 | 70.0 | 78.4 | 82.9 | 85.2 | |

TABLE 16(d)
Flotation Cell Test Results (Study #4)

| | Study #4 | | | | | | | | | | | |
|---|---|---|---|---|---|---|---|---|---|---|---|---|
| | Separation | Supp. | | | | | | | | | | |
| | Aid | Depressant | Dosages (kg/T) | | | Grade (%) Mo | | | | | | |
| Condition | I | II | A | B | Total | 2 mins | 5 mins | 8 mins | 11 mins | 14 mins | 17 mins | 25 mins |
| Control | — | NaSH | — | 10.0 | 10.0 | 23.2 | 24.4 | 26.3 | 26.3 | 26.3 | 26.3 | 26.3 |
| Sample 18c | Compound A16 | S-TGA | 2.0 | 3.0 | 5.0 | 25.6 | 26.0 | 26.1 | 26.2 | 26.2 | 26.2 | 26.2 |
| Sample 18d | Compound A15 | — | 5.0 | — | 5.0 | 25.1 | 25.6 | 25.7 | 25.7 | 25.8 | 25.8 | 25.9 |
| Sample 18e | Compound A15 | — | 5.0 | — | 5.0 | 24.9 | 25.7 | 25.9 | 25.9 | 25.9 | 25.9 | — |

TABLE 16(e)
Flotation Cell Test Results (Study #5)

| | Study #5 | | | | | | | | | | | |
|---|---|---|---|---|---|---|---|---|---|---|---|---|
| | Separation | Supp. | | | | | | | | | | |
| | Aid | Depressant | Dosages (kg/T) | | | Grade (%) Mo | | | | | | |
| Condition | I | II | I | II | Total | 2 mins | 5 mins | 8 mins | 11 mins | 14 mins | 17 mins | 25 mins |
| Control | — | NaSH | — | 10.0 | 10.0 | 4.4 | 2.2 | 0.3 | 0.2 | 0.2 | 0.2 | 0.2 |
| Sample 18c | Compound A14 | S-TGA | 2.0 | 3.0 | 5.0 | 0.4 | 0.6 | 0.6 | 0.7 | 0.7 | 0.7 | 0.7 |
| Sample 18d | Compound A15 | — | 5.0 | — | 5.0 | 1.6 | 1.2 | 1.2 | 1.2 | 1.2 | 1.2 | 1.1 |
| Sample 18e | Compound A16 | — | 5.0 | — | 5.0 | 1.7 | 1.0 | 0.9 | 0.9 | 0.9 | 0.9 | 0.9 |

Overall, as detailed in Table 16 (a), the hydrophilic polymer-modified ammoniated polycarbamide compositions described herein, with and without biopolymers, provided similar recovery of Cu and Mo as the control NaSH, and reduced or replaced NaSH at much lower chemical treatment levels. For example, the hydrophilic polymer-modified polycarbamide composition (Compound A12) and hydrophilic polymer-modified polycarbamide composition with biopolymer (Compound A13) demonstrated comparable Cu—Mo data as the control NaSH at 43.3% lower total chemical treatment level than the control NaSH and showed 60% NaSH reduction.

Moreover, as illustrated in Tables 16(c), along with FIG. 4, the hydrophilic polymer-modified polycarbamide with a sulfur compound and a separately added supplemental depressant (S-TGA) (Sample 18c, Compound A14) demonstrated very similar Mo recovery to NaSH at half the treatment level. Similarly, the hydrophilic polymer-modified ammoniated polycarbamides of Compounds C4 and C5 with sulfur compounds and supplemental depressants mixed therein (Samples 18d and 16e), demonstrate further improvement in Mo recovery. Moreover, the data in Table 16 (b) supports the theory that NaSH will oxidize after 11 minutes and begins to lose effectiveness in depressing Cu, while Samples 18c, 18d, and 18e continues to suppress Cu effectively.

Further, as illustrated in Tables 16d and 16e, each of the Control samples and Samples 168, 18d, and 18e resulted in similar Mo and Cu grades.

It is possible to utilize the various inventive concepts in combination with one another. Additionally, any particular feature recited as relating to a particularly disclosed aspect of the methods and systems of the present disclosure should be interpreted as available for use with all disclosed aspects of the methods and systems of the present disclosure, unless incorporation of the particular feature would be contradictory to the express terms of the disclosed aspect. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

The terminology as set forth herein is for description only and should not be construed as limiting the invention. All references to singular characteristics or limitations of the invention shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The claimed invention is:

1. A separation aid composition comprising:
an ammoniated polycarbamide comprising a reaction product of formaldehyde, urea, and ammonia wherein a mole ratio of formaldehyde to a combination of urea and ammonia is from 1 to 4;
0.01 wt. % to 30 wt. % of a biopolymer; and
0.1 to 50 wt. % of a supplemental depressant.

2. The separation aid composition of claim 1, wherein the mole ratio of formaldehyde to the combination of urea and ammonia is from 1.5 to 3.5.

3. The separation aid composition of claim 2, wherein a mole ratio of formaldehyde to urea is from 0.8 to 2.0.

4. The separation aid composition of claim 1, wherein the separation aid further includes a sulfur compound.

5. The separation aid composition of claim 4, wherein the sulfur compound comprises a sulfite, a sulfate, a thiol-functional compound, a sulfide, a sulfamate, a sulfinic acid, or combinations thereof.

6. The separation aid composition of claim 4, wherein the sulfur compound comprises sodium sulfite.

7. The separation aid of claim 1, wherein the biopolymer comprises lignin-based polymer, a polysaccharide, a starch, a hydrocolloid, flour, soy protein, carboxymethylcellulose, or combinations thereof.

8. The separation aid of claim 7, wherein the lignin-based polymer comprises lignosulfonate.

9. The separation aid composition of claim 1, wherein the supplemental depressant comprises thioglycolic acid (TGA) salts, ethylenediaminetetraacetic acid (EDTA) salts, mercaptosuccinic acid (MSA) salts, thioglycerin (TG) salts, or combinations thereof.

10. The separation aid composition of claim 1, wherein the composition is devoid of sodium hydrosulfide (NaSH).

11. A separation aid composition comprising:
an ammoniated polycarbamide comprising a reaction product of formaldehyde, urea, and ammonia wherein a mole ratio of formaldehyde to a combination of urea and ammonia is from 1 to 4;
0.1 wt. % to 20 wt. % of a hydrophilic polymer; and
0.1 to 50 wt. % of a supplemental depressant.

12. The separation aid composition of claim 11, wherein the mole ratio of formaldehyde to the combination of urea and ammonia is from 1.5 to 3.5.

13. The separation aid composition of claim 11, wherein a mole ratio of formaldehyde to urea is from 0.8 to 2.0.

14. The separation aid composition of claim 11, wherein the separation aid further includes a sulfur compound.

15. The separation aid composition of claim 14, wherein the sulfur compound comprises a sulfite, a sulfate, a thiol-functional compound, a sulfide, a sulfamate, a sulfinic acid, or combinations thereof.

16. The separation aid composition of claim 11, wherein the hydrophilic polymer is an acrylamide polymer.

17. The separation aid composition of claim 11, wherein the composition is devoid of sodium hydrosulfide (NaSH).

18. A method for the separation and recovery of one or more minerals from a mineral ore bulk material, the method comprising:
forming an aqueous pulp comprising water, a mineral ore bulk material, and a separation aid of claim 1;
agitating and floating the aqueous pulp to form a floated mineral concentrate and flotation tailings; and
separately recovering the floated mineral concentrate and flotation tailings.

19. The method of claim 18, wherein recovery of the floated mineral concentrate is the same or similar to that of an otherwise identical method that uses sodium hydrosulfide as a sole separation aid.

20. A method for the separation and recovery of one or more minerals from a mineral ore bulk material, the method comprising:
forming an aqueous pulp comprising water, a mineral ore bulk material, and a separation aid of claim 11;
agitating and floating the aqueous pulp to form a floated mineral concentrate and flotation tailings; and
separately recovering the floated mineral concentrate and flotation tailings.

21. The method of claim 20, wherein recovery of the floated mineral concentrate is the same or similar to that of an otherwise identical method that uses sodium hydrosulfide as a sole separation aid.
